(19) United States
(12) Patent Application Publication
(10) Pub. No.: US 2014/0281849 A1
(43) Pub. Date: Sep. 18, 2014

(54) METHOD, APPARATUS AND ARTICLE FOR PROVIDING SUPPLEMENTAL MEDIA CONTENT INTO A NARRATIVE PRESENTATION

(71) Applicant: MindsightMedia, Inc., Los Angeles, CA (US)

(72) Inventors: Daniel J. Siegel, Santa Monica, CA (US); Caroline S. Welch, Santa Monica, CA (US); Andrew L. Silver, Santa Monica, CA (US); Cynthia P. Brelis, Santa Monica, CA (US)

(73) Assignee: MindsightMedia, Inc., Los Angeles, CA (US)

(21) Appl. No.: 14/209,582

(22) Filed: Mar. 13, 2014

Related U.S. Application Data
(60) Provisional application No. 61/782,261, filed on Mar. 14, 2013.

(51) Int. Cl. G06F 17/24; G06F 3/0482

(52) U.S. Cl. CPC G06F 17/24; G06F 3/0482
USPC 715/202

(57) ABSTRACT

A number of supplemental media content selection periods may be identified within a narrative presentation consisting of a defined number and sequence of scenes. Within each of the supplemental media content selection periods, a number of selectable indicators, each corresponding to an associated aspect of inner awareness of a character included in the narrative may be provided. The aspects of inner awareness may include a thought or cognitive activity of the respective character, an emotion or emotional process of the respective character, or an instinct or bodily perception of the narrative character. Upon selecting a selectable indicator, a supplemental media content presentation logically associated with the aspect of inner awareness of the respective character is provided to a media content consumer. A media editing system can provide various options for transitioning between the narrative presentation and each of the supplemental media content presentations.

### TECHNICAL FIELD

This application is generally related to the presentation of narratives in audio, visual, and audio-visual forms.

### BACKGROUND

The art of storytelling is a form of communication dating back to ancient times. Storytelling allows humans to pass information on to one another for entertainment and instructional purposes. Oral storytelling has a particularly long history and involves the describing of a series of events using words and other sounds. More recently, storytellers have taken advantage of pictures and other visual presentations to relate the events comprising the story. Particularly effective is a combination of audio and visual representations, most commonly found in motion pictures and video.

Until recently, narrative presentations have typically been non-interactive, the series of events forming the story being presented in a predefined order, including a single level of predefined content. Although “Director's Cuts” and similar presentations may provide a media content consumer with additional information related to one or more production aspects of the narrative, such information is often presented as an alternative to the narrative presentation and typically does not allow the media content consumer to conveniently switch between the narrative and the supplemental media. Sometimes, actors or others involved in the production of the narrative will provide the media content consumer with the ability to access supplemental media content related to the narrative. However, such supplemental media content is often offered as an alternative to the narrative and again the media content consumer is left with no way to conveniently switch between the narrative and the supplemental media.

Narratives providing the media content consumer with an ability to affect the plotline provide another alternative. In such narratives, at various decision points in the narrative media content consumer input may be solicited. Dependent upon the media content consumer input, and perhaps on prior media consumer input or plotline events to maintain narrative coherency, the plotline of the narrative can be altered and alternative plotlines explored. For example, many video games and instructional computer programs may present a series of events where media content consumer input selections change the order of presentation of the events, and can cause the computer to present some events, while not presenting other events. Thus, a number of branching points exist in the narrative presentation at which the user selection determines which of the events will be presented and the order of presentation. By varying selections, the user is presented with a different narrative each time.

Common forms of the narrative presentation, such as books, audio tapes, video tapes, motion pictures, and theatrical productions limit the user's ability to explore a particular character's motivations and subconscious mind. While some authors may provide a great deal of insight into a character's mental impressions, the level of insight that the user receives is necessarily limited by the narrative presentation. The actions of individuals, and consequently the events and interpersonal activities of an individual, can be influenced by intangible forces such as an individual's conscious and sub-conscious thought, emotional state, and feelings or “gut instinct.” The depth and extent of such intangible factors and their influence on an individual's actions, words, and behavior are difficult to explore and convey in the tight temporal confines of a fluidly moving narrative. The difficulty is compounded when such intangible factors are influencing multiple characters in the narrative. This often presents a problem for readers and listeners who wish to delve more deeply into a character's motivation within the narrative. On the other hand, the inclusion of such supplemental material in the narrative can present an annoyance to those media content consumers not wishing to delve as deeply as the author has intended, dissuading those media content consumers from listening to and/or viewing the particular narrative presentation.

### SUMMARY

A narrative presentation may be considered a defined sequence of scenes that tells a story to a media content consumer. Narratives are fundamental to storytelling, games, and educational materials. Characters within the narrative will interact with other characters, other elements in the story, and the environment itself as the narrative presentation progresses. At times, many media content consumers may desire a better or more thorough understanding of any number of aspects of inner awareness of a character in the narrative presentation such as thoughts, emotions, or instincts that motivate the character through the narrative presentation. In one example, media content consumers may desire a better understanding of how a character evolves, changes, or develops over the course of the narrative presentation.

During the production of the narrative presentation, additional content answering some of the questions about a particular character's motivation or development may be captured by the production team. However, based on time constraints or content limitations such additional content may be excluded from the final narrative presentation. Providing the production team with the ability to integrate or otherwise make available additional content without increasing the duration of the narrative presentation may therefore provide an attractive compromise that permits the inclusion of additional content to satisfy both the production team and those media content consumers or aficionados desiring such, while retaining a streamlined narrative presentation meeting both temporal and content requirements.

Within the narrative presentation an editor or editing team can identify supplemental media content selection periods during which indicators may be used to indicate the availability of supplemental media content to a media content consumer viewing the narrative. Various indicators may be used to indicate the availability of supplemental media content. For example a first indicator (e.g., icon or visual effect) may be used to indicate the availability of supplemental media content associated with a particular character's thoughts or cognitive activities, a second indicator or effect may be associated with the particular character's emotions or emotional processes, while a third indicator or effect may be associated with the particular character's instincts or bodily sensations. The indicators inserted into the narrative presentation by the editor or editing team may include user selectable indicators such as touch or pointer selectable icons or screen regions.

When a media content consumer selects one of the supplemental media content icons appearing in the narrative presentation, the playback of supplemental media content logically associated with the indicator may commence. For example, responsive to receipt of a media content consumer input corresponding to selection of a first character's thoughts or cognitive activities at a point in the narrative presentation, a supplemental media content presentation associated with the first character's thoughts at the point in the narrative when the media content consumer provided the input may be provided. In at least some instances, the production or editing teams may elect to either pause or reduce the frame rate of the narrative presentation while the supplemental media content presentation is provided to the media content consumer. In at least some instances, the production or editing teams may select a transition mode between the narrative presentation and the supplemental media content presentation. Such transition modes may include effects such as enlarging a display area associated with the supplemental media content presentation while reducing the display area of the narrative presentation or reducing the brightness of the narrative presentation while increasing the brightness of the supplemental media content presentation.

Each supplemental media content presentation may include non-fictional or fictional information regarding a character's thoughts, emotions or instincts. Thus, a non-fictional supplemental media content presentation may be used to explore Abraham Lincoln's documented thoughts, emotions, or instincts regarding the Emancipation Proclamation throughout the motion picture “Lincoln” while a fictional supplemental media content presentation may be used to delve deeper into the thoughts, emotions or instincts of Roger O. Thornhill at various points throughout the motion picture “North by Northwest.” At the conclusion of the supplemental media content presentation, the media content consumer may be prompted for additional supplemental media content selections or the narrative presentation may resume.

The production or editing teams can also select a transition mode between the supplemental media content presentation and the narrative presentation. Such transition modes may include effects such as enlarging a display area associated with the narrative presentation while reducing the display area of the supplemental media content presentation or reducing the brightness of the supplemental media content presentation while increasing the brightness of the narrative presentation. The production or editing teams can also determine the point at which the narrative is resumed. Thus, for example the narrative may resume at the point where the media content consumer selected the supplemental media content presentation, or at a point prior to where the media content consumer selected the supplemental media content presentation. Thus, the continuity of the narrative presentation may be beneficially preserved even if a media content consumer selects a number of supplemental media content presentations.

A method for editing at least one supplemental media content presentation into a narrative presentation consisting of a defined sequence of scenes using a processor-based media editing system may be summarized as including identifying over the course of the narrative presentation a number of supplemental media content selection periods during which at least one supplemental media content presentation is available, each of the selection periods having a respective start point, duration, and end point in the narrative presentation; for each of the supplemental media content selection periods, providing a number of media content consumer perceptible and selectable indicators in the narrative presentation during all or a portion of the respective supplemental media content period, each selectable indicator representative of an aspect of inner awareness associated with each of a number of characters; and each selectable indicator logically associated with a respective supplemental media content presentation including information regarding the respective aspect of inner awareness of the respective character at a point in the narrative presentation selected by the media content consumer; and for each supplemental media content presentation, identifying at least one respective transition mode between the narrative presentation and each supplemental media content presentation, the respective transition mode specifying a transition effect for segueing between the narrative presentation and the respective supplemental media content presentation.

The method may further include identifying over the course of at least one supplemental media content presentation a number of subordinate supplemental media content selection periods during which at least one subordinate supplemental media content presentation is available, each subordinate supplemental media content selection period having a respective start point, duration, and end point in the respective supplemental media content presentation; for each of the subordinate supplemental media content selection periods, providing a number of media content consumer perceptible and selectable indicators in the supplemental media content presentation during all or a portion of the respective subordinate supplemental media content selection period; each indicator representative of an aspect of inner awareness for each of a number of characters included in the supplemental media content presentation; and each indicator logically associated with a respective subordinate supplemental media content presentation including information regarding the respective aspect of inner awareness of the respective character included in the supplemental media content presentation at a point in the supplemental media content presentation selected by the media content consumer; and for each subordinate supplemental media content presentation, identifying at least one respective transition mode between the supplemental media content presentation and each subordinate supplemental media content presentation, the respective transition mode specifying a transition effect for segueing between the supplemental media content presentation and the respective subordinate supplemental media content presentation.

The method may further include identifying a temporal transition relationship between a departure transition event from the narrative presentation to the supplemental media content presentation and return transition event from the supplemental media content presentation to the narrative presentation.

Identifying a temporal transition relationship between the departure transition event from the narrative presentation to the supplemental media content presentation and the return transition event from the supplemental media content presentation to the narrative presentation may include one of identifying the temporal transition relationship that causes the return transition event to return to the narrative presentation at a point in the narrative when the departure transition event occurred; or identifying the temporal transition relationship that causes the return transition event to return to the narrative presentation at a defined point in the narrative presentation prior to when the departure transition event occurred.

Identifying a temporal transition relationship between the departure transition event from the narrative presentation to the supplemental media content presentation and the return transition event from the supplemental media content presentation to the narrative presentation may include identifying the temporal transition relationship that causes the return transition event to autonomously return to the narrative presentation at the start point of the respective supplemental media content selection period responsive to a selection of a supplemental media content presentation by a media content user within a defined interval prior to the end point of the respective supplemental media content selection period.

Identifying at least one respective transition mode between the narrative presentation and each supplemental media content presentation, the respective transition mode specifying a transition effect for segueing between the supplemental media content presentation and the respective subordinate supplemental media content presentation may include at least one of specifying the transition effect causing a decrease in size of a narrative display area and a contemporaneous increase in size of a supplemental media content display area; and specifying the transition effect causing a reduction in intensity of a narrative display area and a contemporaneous increase in intensity of a supplemental media content display area.

The method may further include for each supplemental media content selection period, selecting a standby mode entered by the narrative presentation while a supplemental media content presentation is provided to a media content consumer. Selecting a standby mode may include at least one of selecting the standby mode that causes the narrative presentation to halt during the supplemental media content presentation; selecting the standby mode that causes at least a portion of the narrative existent between a defined start point and a defined end point within the respective supplemental media content selection period to cyclically loop during the supplemental media content presentation; or selecting the narrative presentation standby mode that causes the narrative presentation to progress at a reduced frame rate during the supplemental media content presentation.

The method may further include for each supplemental media content selection period, selecting at least one character included in the narrative presentation, each selected character having at least one associated supplemental media content presentation logically associated with an aspect of inner awareness of the respective character; and autonomously identifying each of the selected characters by the processor-based media editing system for at least a portion of the duration of the respective supplemental media content selection period.

Autonomously identifying each of the selected characters by the processor-based media editing system for at least a portion of the duration of the respective supplemental media content selection period may include autonomously identifying each of the selected characters using a processor-based facial recognition.

The method may further include for each of the supplemental media content selection periods, providing a number of media content consumer perceptible, non-selectable, indicators in the narrative presentation, each non-selectable indicator representative of an aspect of inner awareness for each of the number of characters; and each non-selectable indicator logically associated with a respective supplemental media content presentation previously accessed by the media content consumer during the respective supplemental media content selection period.

For each of the supplemental media content selection periods, providing a number of media content consumer perceptible and selectable indicators in the narrative presentation during all or a portion of the respective supplemental media content period, each indicator representative of one aspect of inner awareness for each of a number of characters may include providing a number of selectable indicators, each representative an aspect of inner awareness that includes at least: the aspect of inner awareness corresponding to a thought or cognitive activity of the respective character; the aspect of inner awareness corresponding to an emotion or emotional process of the respective character; and the aspect of inner awareness corresponding to an instinct or bodily sensation of the respective character.

Providing a selectable indicator representative of an aspect of inner awareness that may include at least an aspect of inner awareness corresponding to a thought or cognitive activity of the respective character; an aspect of inner awareness corresponding to an emotion or emotional process of the respective character; and an aspect of inner awareness corresponding to an instinct or bodily sensation of the respective character may include at least one of providing in the narrative presentation a selectable indicator representative of the aspect of inner awareness corresponding to a thought or cognitive activity of a character on or about a first portion of a representation of the respective character; providing in the narrative presentation a selectable indicator representative of the aspect of inner awareness corresponding to an emotion or emotional process of a character on or about a second portion of a representation of the respective character; and providing in the narrative presentation a selectable indicator representative of the aspect of inner awareness corresponding to an instinct or bodily sensation of a character on or about a third portion of a representation of the respective character.

Providing a selectable indicator representative of an aspect of inner awareness that may include at least an aspect of inner awareness corresponding to a thought or cognitive activity of the respective character; an aspect of inner awareness corresponding to an emotion or emotional process of the respective character; and an aspect of inner awareness corresponding to an instinct or bodily sensation of the respective character may include at least one of providing in the narrative presentation a selectable indicator representative of the aspect of inner awareness corresponding to a thought or cognitive activity of the respective character on or about a head portion of a representation of the respective character; providing in the narrative presentation a selectable indicator representative of the aspect of inner awareness corresponding to an emotion or emotional process of the respective character on or about a chest portion of a representation of the respective character; and providing in the narrative presentation a selectable indicator representative of the aspect of inner awareness corresponding to an instinct or bodily sensation of the respective character on or about an abdominal portion of a representation of the respective character.

The method may further include selecting at least one display parameter for each of the number of selectable indicators. Selecting at least one display parameter may include selecting at least one display effect on or proximate at least one of a media content consumer selectable indicator including an icon logically associated with a supplemental media content presentation logically associated with the respective character; and a media content consumer selectable indicator including an indicator disposed on or about all or a portion of a representation of a character, the indicator logically associated with a supplemental media content presentation logically associated with the respective character.

Selecting at least one display effect may include selecting at least one of a change in display intensity; a change in display color; and a cyclical change in alternating portions of display location resulting to cause a shimmer effect.

Selecting at least one display effect on or proximate a media content consumer selectable indicator including an indicator disposed on or about all or a portion of a representation of a character may include selecting at least one of a display effect directly on or proximate at least a portion of a representation of the respective character appearing in the narrative presentation; or a display effect directly on or proximate at least a portion of a representation corresponding to the respective character appearing external to the narrative presentation.

Selecting at least one display parameter for each of the number of selectable indicators may further include selecting a duration of the at least one display effect in the narrative presentation equal to a duration of the respective supplemental media content selection period; and selecting a duration of the at least one display effect in the narrative presentation less than a duration of the respective supplemental media content selection period.

The method may further include for each of the number of selectable indicators, identifying a media content consumer input indicative of a selection of the respective indicator.

Identifying a media content consumer input indicative of a selection of the respective indicator may include at least one of identifying a non-contact, gesture based, input using a human hand or pointer to indicate selection of the respective indicator; identifying a contact, touch based, input using a human hand or pointer to indicate selection of the respective indicator; and identifying a pointer based input using a pointing device to indicate selection of the respective indicator.

Providing a number of media content consumer perceptible and selectable indicators in the narrative presentation during all or a portion of the respective supplemental media content period, each indicator representative of an aspect of inner awareness for each of a number of characters included in the narrative; and each indicator logically associated with a respective supplemental media content presentation including information regarding the respective aspect of inner awareness of the respective character at a point in the narrative presentation selected by the media content consumer; may include providing a number of media content consumer perceptible and selectable indicators in the narrative presentation during all or a portion of the respective supplemental media content period, each indicator representative of an aspect of inner awareness for each of at least two characters included in the narrative; and each indicator logically associated with a respective supplemental media content presentation including information regarding the respective aspect of inner awareness of the respective character at a point in the narrative presentation selected by the media content consumer.

The method may further include defining a presentation sequence for each of the number of supplemental media content presentations logically associated with each of the at least two characters included in the narrative presentation.

Defining a presentation sequence for the number of supplemental media content presentations logically associated each of the at least two characters may include defining a presentation sequence that causes the presentation of each of the number of supplemental media content presentations logically associated with a first character included in the narrative presentation prior to a presentation of any of the number of supplemental media content portions logically associated with a second character included in the narrative presentation.

Defining a presentation sequence that may cause the presentation of each of the number of supplemental media content presentations logically associated with a first character included in the narrative presentation prior to a presentation of any of the number of supplemental media content portions logically associated with a second character included in the narrative presentation may include at least one of defining a presentation sequence that causes the presentation of each of the number of supplemental media content presentations logically associated with the first character included in the narrative presentation prior to the presentation of any of the number of supplemental media content presentations logically associated with the second character included in the narrative presentation for the duration of each supplemental media content period; or defining a presentation sequence that causes the presentation of each of the number of supplemental media content presentations logically associated with the first character included in the narrative presentation prior to the presentation of any of the number of supplemental media content presentations logically associated with the second character included in the narrative presentation for a duration narrative presentation.

Defining a presentation sequence for the number of supplemental media content presentations logically associated with each of the at least two characters may include defining a presentation sequence that causes the presentation of each of the number of supplemental media content presentations logically associated with at least one of the aspects of inner awareness associated with the first character included in the narrative presentation prior to the presentation of any of the number of supplemental media content presentations logically associated with at least one of the aspects of inner awareness associated with the second character included in the narrative presentation.

Defining a presentation sequence for the number of supplemental media content presentations logically associated each of the at least two characters included in the narrative may include defining by the media content consumer a presentation sequence for the presentation of each of a number of supplemental media content presentations for each of the at least two characters.

Defining by the media content consumer a presentation sequence for the presentation of each of a number of supplemental media content presentations for each of the at least two characters may include defining by the media content consumer a presentation sequence for the presentation of each of a number of supplemental media content presentations for each of the at least two characters corresponding to a selectable indicator selection sequence provided by the media content consumer.

A system for editing at least one supplemental media content presentation into a narrative presentation consisting of a defined sequence of scenes may be summarized as including a first nontransitory storage including data representative of the narrative presentation and a number of supplemental media content presentations; at least one user interface; and at least one processor with machine executable instructions that when executed by the at least one processor, cause the at least one processor to provide a user with the ability via the at least one user interface to: identify over the course of the narrative presentation a number of supplemental media content selection periods during which at least one supplemental media content presentation is available, each of the selection periods having a respective start point, duration, and end point in the narrative presentation; for each of the supplemental media content selection periods, provide a number of media content consumer perceptible and selectable indicators in the narrative presentation during all or a portion of the respective supplemental media content period, each selectable indicator representative of an aspect of inner awareness associated with each of a number of characters included in the narrative presentation; and each indicator logically associated with a respective supplemental media content presentation including information regarding the respective aspect of inner awareness of the respective character at a point in the narrative presentation selected by the media content consumer; and for each supplemental media content presentation, identify at least one respective transition mode between the narrative presentation and each supplemental media content presentation, the respective transition mode specifying a transition effect for segueing between the narrative presentation and the respective supplemental media content presentation.

The machine executable instructions may further cause the at least one processor to provide a user with the ability via the user interface to identify over the course of at least one supplemental media content presentation a number of subordinate supplemental media content selection periods during which at least one subordinate supplemental media content presentation is available, each subordinate supplemental media content selection period having a respective start point, duration, and end point in the respective supplemental media content presentation; for each of the subordinate supplemental media content selection periods, provide a number of media content consumer perceptible and selectable indicators in the supplemental media content presentation during all or a portion of the respective subordinate supplemental media content selection period; each selectable indicator representative of an aspect of inner awareness for each of a number of characters included in the respective supplemental media content presentation; and each indicator logically associated with a respective subordinate supplemental media content presentation including information regarding the respective aspect of inner awareness of the respective character at a point in the supplemental media content presentation selected by the media content consumer; and for each supplemental media content presentation, identify at least one respective transition mode between the supplemental media content presentation and each subordinate supplemental media content presentation, the respective transition mode specifying a transition effect for segueing between the supplemental media content presentation and the respective subordinate supplemental media content presentation.

The machine executable instructions may further cause the at least one processor to provide a user with the ability via the user interface to identify a temporal transition relationship between a departure transition event from the narrative presentation to the supplemental media content presentation and return transition event from the supplemental media content presentation to the narrative presentation. The temporal transition relationship may include one of the temporal transition relationship that causes the return transition event to return to the narrative presentation at a point in the narrative when the departure transition event occurred; or the temporal transition relationship that causes the return transition event to return to the narrative presentation at a defined point in the narrative presentation prior to when the departure transition event occurred. The temporal transition relationship may include the relationship that causes the return transition event to autonomously return to the narrative presentation at the start point of the respective supplemental media content selection period responsive to a selection of a supplemental media content presentation by a media content user within a defined interval prior to the end point of the respective supplemental media content selection period.

The machine executable instructions may further cause the at least one processor to provide the user with the ability via the user interface to specify the transition effect that causes a decrease in size of a narrative presentation display area and a contemporaneous increase in size of a supplemental media content presentation display area; and specify the transition effect that causes a reduction in intensity of a narrative presentation display area and a contemporaneous increase in intensity of a supplemental media content presentation display area.

The machine executable instructions may further cause the at least one processor to provide the user with the ability via the user interface to for each supplemental media content selection period, select a standby mode entered by the narrative presentation while a supplemental media content presentation is provided to a media content consumer. The standby mode may include at least one of the standby mode that causes the narrative presentation to halt during the supplemental media content presentation; the standby mode that causes at least a portion of the narrative existent between a defined start point and a defined end point within the respective supplemental media content selection period to cyclically loop during the supplemental media content presentation; or the standby mode that causes the narrative presentation to progress at a reduced frame rate during the supplemental media content presentation.

The machine executable instructions may further cause the at least one processor to provide the user with the ability via the user interface for each supplemental media content selection period, select at least one character in the narrative presentation, each selected character having at least one associated supplemental media content presentation logically associated with an aspect of inner awareness; and autonomously identify each of the selected characters using facial recognition for at least a portion of the duration of the respective supplemental media content selection period.

The machine executable instructions may further cause the at least one processor to provide the user with the ability via the user interface to for each of the supplemental media content selection periods, provide a number of media content consumer perceptible, non-selectable, indicators in the narrative presentation, each non-selectable indicator representative of an aspect of inner awareness for each of the number of characters; and each non-selectable indicator logically associated with a respective supplemental media content presentation previously accessed by the media content consumer during the respective supplemental media content selection period.

The machine executable instructions may further cause the at least one processor to provide the user with the ability via the user interface to provide a selectable indicator representative of an aspect of inner awareness that includes at least the aspect of inner awareness corresponding to a thought or cognitive activity of the respective character; the aspect of inner awareness corresponding to an emotion or emotional process of the respective character; and providing in the narrative a selectable indicator representative of the aspect of inner awareness corresponding to an instinct or bodily sensation of the respective character.

The machine executable instructions may further cause the at least one processor to provide the user with the ability via the user interface to provide in the narrative presentation a selectable indicator representative of the aspect of inner awareness corresponding to a thought or cognitive activity of a character on or about a first portion of a representation of the respective character; provide in the narrative presentation a selectable indicator representative of the aspect of inner awareness corresponding to an emotion or emotional process of a character on or about a second portion of a representation of the respective character; and provide in the narrative presentation a selectable indicator representative of the aspect of inner awareness corresponding to an instinct or bodily sensation of a character on or about a third portion of a representation of the respective character.

The machine executable instructions may further cause the at least one processor to provide the user with the ability via the user interface to provide in the narrative presentation a selectable indicator representative of the aspect of inner awareness corresponding to a thought or cognitive activity of the respective character on or about a head portion of a representation of the respective character; provide in the narrative presentation a selectable indicator representative of the aspect of inner awareness corresponding to an emotion or emotional process of the respective character on or about a chest portion of a representation of the respective character; and provide in the narrative presentation a selectable indicator representative of the aspect of inner awareness corresponding to an instinct or bodily sensation of the respective character on or about an abdominal portion of a representation of the respective character.

The machine executable instructions may further cause the at least one processor to provide the user with the ability via the user interface to select at least one display parameter for each of the number of selectable indicators.

The machine executable instructions may further cause the at least one processor to provide the user with the ability via the user interface to select at least one display effect on or proximate at least one of a media content consumer selectable indicator including an icon logically associated with a supplemental media content presentation logically associated with the respective character; and a media content consumer selectable indicator including an indicator disposed on or about all or a portion of a representation of a character, the indicator logically associated with a supplemental media content presentation logically associated with the respective character.

The machine executable instructions may further cause the at least one processor to provide the user with the ability via the user interface to select at least one display effect that includes at least one of a change in display intensity; a change in display color; and a cyclical change in alternating portions of display location resulting to cause a shimmer effect.

The machine executable instructions may further cause the at least one processor to provide the user with the ability via the user interface to select at least one display effect on or proximate a media content consumer selectable indicator including an indicator disposed on or about all or a portion of a representation of a character included in the narrative presentation including at least one of a display effect directly on or proximate at least a portion of a representation of the respective character included in the narrative presentation; or a display effect directly on or proximate at least a portion of a representation of the respective character external to the narrative presentation.

The machine executable instructions may further cause the at least one processor to provide the user with the ability via the user interface to select at least one display parameter for each of the number of selectable indicators including at least one of a duration of the at least one display effect in the narrative presentation equal to a duration of the respective supplemental media content selection period; and a duration of the at least one display effect in the narrative presentation less than a duration of the respective supplemental media content selection period.

The machine executable instructions may further cause the at least one processor to provide the user with the ability via the user interface to for each of the number of selectable indicators, identify a media content consumer input indicative of a selection of the respective indicator.

The machine executable instructions may further cause the at least one processor to provide the user with the ability via the user interface to identify a media content consumer input indicative of a selection of the respective indicator including at least one of a non-contact, gesture based, input using a human hand or pointer to indicate selection of the respective indicator; a contact, touch based, input using a human hand or pointer to indicate selection of the respective indicator; and a pointer based input using a pointing device to indicate selection of the respective indicator.

The machine executable instructions may further cause the at least one processor to provide the user with the ability via the user interface to provide a number of media content consumer perceptible and selectable indicators in the narrative presentation during all or a portion of the respective supplemental media content period, each indicator representative of an aspect of inner awareness for each of at least two characters included in the narrative presentation; and each selectable indicator logically associated with a respective supplemental media content presentation including information regarding the respective aspect of inner awareness of the respective character at a point in the narrative presentation selected by the media content consumer.

The machine executable instructions may further cause the at least one processor to provide the user with the ability via the user interface to define a presentation sequence for each of the number of supplemental media content presentations logically associated with each of the at least two characters included in the narrative presentation.

The machine executable instructions may further cause the at least one processor to provide the user with the ability via the user interface to define a presentation sequence that causes the presentation of each of the number of supplemental media content presentations logically associated with a first character included in the narrative prior to a presentation of any of the number of supplemental media content portions logically associated with a second character included in the narrative. The presentation sequence may include at least one of a presentation sequence that causes the presentation of each of the number of supplemental media content presentations logically associated with the first character included in the narrative presentation prior to the presentation of any of the number of supplemental media content presentations logically associated with the second character included in the narrative presentation for the duration of each supplemental media content period; or a presentation sequence that causes the presentation of each of the number of supplemental media content presentations logically associated with the first character included in the narrative presentation prior to the presentation of any of the number of supplemental media content presentations logically associated with the second character included in the narrative presentation for a duration of the narrative presentation.

The machine executable instructions may further cause the at least one processor to provide the user with the ability via the user interface to define a presentation sequence that causes the presentation of each of the number of supplemental media content presentations logically associated with at least one of the aspects of inner awareness associated with the first character included in the narrative presentation prior to the presentation of any of the number of supplemental media content presentations logically associated with at least one of the aspects of inner awareness associated with the second character included in the narrative presentation.

The machine executable instructions may further cause the at least one processor to provide the user with the ability via the user interface to define by the media content consumer a presentation sequence for the presentation of each of a number of supplemental media content presentations for each of the at least two characters included in the narrative presentation.

The machine executable instructions may further cause the at least one processor to provide the user with the ability via the user interface to define by the media content consumer a presentation sequence for the presentation of each of a number of supplemental media content presentations for each of the at least two characters included in the narrative presentation corresponding to a selectable indicator selection sequence provided by the media content consumer.

### BRIEF DESCRIPTION OF THE DRAWINGS

In the drawings, identical reference numbers identify similar elements or acts. The sizes and relative states of elements in the drawings are not necessarily drawn to scale. For example, the positions of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1A is a display diagram showing an example processor-based media editing system for inserting supplemental media content presentations into a narrative presentation consisting of a defined sequence of scenes, according to one illustrated embodiment.

FIG. 1B is an enlarged display diagram showing a portion of the example processor-based media editing system depicted in FIG. 1, according to one illustrated embodiment.

FIG. 1C is an enlarged display diagram showing another portion of the example processor-based media editing system depicted in FIG. 1, according to one illustrated embodiment.

FIG. 1D is an enlarged display diagram showing yet another portion of the example processor-based media editing system depicted in FIG. 1, according to one illustrated embodiment.

FIG. 2A is a display diagram showing an example fantasy narrative presentation display screen including a first selectable indicator type to indicate a character having at least one available supplemental media content presentation to a media content consumer, according to one illustrated embodiment.

FIG. 2B is a display diagram showing an example dramatic narrative presentation display screen including a second selectable indicator type to indicate to a media content consumer two characters, each having at least one available supplemental media content presentation, according to one illustrated embodiment.

FIG. 2C is a display diagram showing an example animated narrative presentation display screen including a third selectable indicator type to indicate to a media content consumer two characters, each having at least one available supplemental media content presentation, according to one illustrated embodiment.

FIG. 3 is a display diagram showing an example processor-based media editing system for inserting subordinate supplemental media content presentations into a supplemental media content presentation consisting of a defined sequence of scenes, according to one illustrated embodiment.

FIG. 4 is a display diagram showing an example processor-based media editing system for inserting a temporal relationship between the departure point where a narrative presentation transitions to a supplemental media content presentation and the return point where the supplemental media content presentation transitions back to the narrative presentation, according to one illustrated embodiment.

FIG. 5A is a display diagram showing an example processor-based media editing system for inserting a first transition mode at the departure point where a narrative presentation transitions to a supplemental media content presentation and at the return point where the supplemental media content presentation transitions back to the narrative presentation, according to one illustrated embodiment.

FIG. 5B is a display diagram showing an example processor-based media editing system for inserting a second transition mode at the departure point where a narrative presentation transitions to a supplemental media content presentation and at the return point where the supplemental media content presentation transitions back to the narrative presentation, according to one illustrated embodiment.

FIG. 6 is a high-level flow diagram showing a method controlling an example processor-based media editing system for inserting supplemental media content presentations into a narrative presentation consisting of a defined sequence of scenes, according to one illustrated embodiment.

FIG. 7 is a high-level flow diagram showing a method controlling an example processor-based media editing system for inserting subordinate supplemental media content presentations into a supplemental media content presentation consisting of a defined sequence of scenes, according to one illustrated embodiment.

FIG. 8 is a high-level flow diagram showing a method controlling an example processor-based media editing system for inserting transitions between a narrative presentation and a supplemental media content presentation, according to one illustrated embodiment.

FIG. 9 is a high-level flow diagram showing a method controlling an example processor-based media editing system for presenting multiple supplemental media content presentations in an order determined by a media content consumer, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with processors, user interfaces, nontransitory storage media, media production, or media editing techniques have not been shown or described in detail to avoid unnecessarily obscuring descriptions of the embodiments. Additionally, human physiological structures and psychological processes have also not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein the terms “production team” and “production or editing teams” should be understood to refer to a team including one or more persons responsible for any aspect of producing, generating, sourcing, or originating media content that includes any form of human perceptible communication including, without limitation, audio media presentations, visual media presentations, and audio/visual media presentations.

As used herein the terms “editing team” and “production or editing teams” should be understood to refer to a team including one or more persons responsible for any aspect of editing, altering, joining, or compiling media content that includes any form of human perceptible communication including, without limitation, audio media presentations, visual media presentations, and audio/visual media presentations. In at least some instances, one or more persons may be included in both the production team and the editing team.

As used herein the term “aspects of inner awareness” should be understood to refer to inner psychological and physiological processes and reflection on and awareness of inner mental and somatic life. Such awareness can include, but is not limited to the mental impressions of an individual's internal cognitive activities, emotional processes, or bodily sensations. Manifestations of various aspects of inner awareness may include, but are not limited to self-awareness or introspection. Generally, the aspects of inner awareness are intangible and often not directly externally visible but are instead inferred based upon a character's words, actions, and outwardly expressed emotions. Other terms related to aspects of inner awareness may include, but are not limited to, metacognition (the psychological process of thinking about thinking), emotional awareness (the psychological process of reflecting on emotion), and intuition (the psychological process of perceiving somatic sensations or other internal bodily signals that shape thinking). Understanding a character's aspects of inner awareness may provide enlightenment to a media content consumer on the underlying reasons why a character acted in a certain manner within a narrative presentation. Providing media content including aspects of a character's inner awareness enables production or editing teams to include additional material that expands the narrative presentation for media content consumers seeking a better understanding of the characters within the narrative presentation.

The headings and Abstract of the Disclosure provided herein are for convenience only and do not interpret the scope or meaning of the embodiments.

FIG. 1A shows an example processor-based media editing system 100 for inserting a number of supplemental media content presentations 106aa-106nn (collectively “supplemental media content presentations 106”) each associated with a mental state category of a character in a narrative presentation 102 consisting of a defined sequence of scenes 104, according to an illustrative embodiment. FIGS. 1B, 1C, and 1D each show an enlarged view of the media editing system 100 depicted in FIG. 1A to facilitate discussion of additional operational details of the media editing system 100. The narrative presentation 102 consists of a defined number of scenes 104a-104n (collectively “narrative scenes 104”) that occur in a defined order and that convey a fictional or non-fictional story, tale, or chronicle to a media content consumer. Each of the narrative scenes 104 can be of any temporal duration and may be comprised of any number of individual frames 130.

The narrative presentation 102 is used to convey knowledge and information within a society and across generations and is fundamental to storytelling, games, and educational materials. The narrative presentation 102 can be provided as an audio-only presentation, as a video-only presentation, or as a multimedia presentation that combines at least an audio presentation with a parallel track video presentation. In at least some implementations, the narrative 102 may be stored as one or more digital files on a nontransitory storage media 150 that is communicably coupled either directly (e.g., via a bus) or indirectly (e.g., via a local area network (“LAN”), wide area network (“WAN”) or even worldwide network (e.g., the Internet) to the media editing system 100. In at least some implementations, the supplemental media content 106 may be stored as one or more digital files on a nontransitory storage media 152 that is communicably coupled either directly (e.g., via a bus) or indirectly (e.g., via a local area network (“LAN”), wide area network (“WAN”) or even worldwide network (e.g., the Internet) to the media editing system 100. The narrative presentation 102 can be at any stage of completion from first assembly by an editor to a final cut that has been reviewed and approved by both production and editing teams. In at least some instances, the narrative presentation 102 is a non-branching presentation in which the media content consumer cannot alter the sequence of scenes 104.

Editing the narrative presentation 102 requires compromise in order to make the narrative presentation 102 appealing to the broadest possible audience. In practical terms, the production and editing teams responsible for assembling the narrative presentation 102 must balance the quantity of detail provided to a media content consumer against the impact such detail may have on the overall flow or feel of the narrative presentation 102. Inserting an excessive quantity of detail on the progression of a particular character's mental state (e.g., thoughts, emotions, and instincts) throughout the narrative presentation 102 may quench an aficionado media content consumer's thirst for detail while unacceptably slowing the pace of the narrative presentation 102 for a general audience media content consumer. Conversely, eliminating details on the progression of a particular character's mental state through the narrative presentation 102 may make the character appear capricious or whimsical, satisfying neither an aficionado nor general media content consumer. Successful production and editing teams thus must often strike a balance by providing sufficient details on a particular character's cognitive activities, emotional processes and instincts or bodily sensations throughout the narrative presentation 102 to satisfy a broad audience of media content consumers while retaining a relatively fluid narrative presentation having a “feel” or “flow” appropriate for the subject of the narrative presentation 102 and the presentation style of the editor and director.

The media editing system 100 beneficially permits a system user to identify or otherwise define any number of supplemental media content selection periods 105a-105c (collectively “supplemental media content selection periods 105”) within in the narrative presentation 102. During each of the supplemental media content selection periods 105 a number of supplemental media presentations 106, each associated with one or more aspects of a character's inner awareness may be accessed by a media content consumer. Each supplemental media content presentation 106 provides the media content consumer with additional information on various aspects of a character's inner awareness and may include insight into character aspects such as their thoughts, emotions, or instincts. Such inner awareness is exemplified by, although not limited to, a character's cognitive activities, a character's emotional processes, a character's instincts or bodily sensations or any combination thereof. Providing a media content consumer with a sense of a character's inner awareness within the temporal and plot confines of the narrative presentation 102 is often difficult. By providing the media content consumer with access to supplemental media content presentations 106 at points in the narrative presentation 102 deemed relevant by the production and editing teams, information regarding one or more inner awareness aspects of a character is available to media content consumers desirous of such information, while media content consumers interested in a more streamlined narrative presentation 102 are able to avoid the more detailed supplemental media presentations 106.

The supplemental media presentations 106, much like the narrative presentation 102, consist of a defined sequence of scenes that provide the media content consumer with additional context underlying the behavior and actions of the character. While some of the supplemental media content presentations 106 may be used to provide background information (e.g., reminisces of earlier scenes in the narrative presentation or even earlier events that have ostensibly occurred outside of the narrative presentation 102) concerning a character, other supplemental media content presentations 106 may be used to explore deeper, psychodynamic aspects of a character's cognitive activities, emotional processes, and instincts or bodily sensations. At least some supplemental media content presentations 106 may include the character's expectations of the future, possibly even foreshadowing or even including portions of scenes from later in the narrative presentation 102.

The supplemental media content presentations 106 are logically associated with particular supplemental media content selection periods 105 positioned temporally throughout the narrative presentation 102. Such logical association permits the media content consumer access to only those supplemental media presentations 106 that are logically related and temporally relevant to the character for a limited time period during the running of the narrative presentation 102. The use of supplemental media content selection periods 105 thus prevents the media content consumer from accessing during the opening scene of a narrative presentation 102 a supplemental media content presentation 106 associated with the character in a closing scene of the narrative presentation 102. Such logical association between supplemental media content presentation 105, the supplemental media content selection period 106, and the narrative presentation 102 thereby preserves the integrity of the production and editing team's vision for the plot, presentation, and story development of the narrative presentation 102.

Contextually, each of the supplemental media content presentations 106 is associated with an aspect of a particular character that is either not readily perceivable by a media content consumer or is difficult to convey to a media content consumer via audio, visual, or audio/visual media. Such imperceptible character aspects may include, although are not limited to, the cognitive activities of the character, the emotional processes of the character, and the bodily sensations experienced by the character.

Providing the ability for the media content consumer to occasionally delve deeper into one or more imperceptible aspects of a character during the narrative presentation 102 may advantageously satisfy both the need of some media content consumers to “know more” about a character and the need of production or editing teams to “tell more” about one or more aspects of the character that would otherwise remain imperceptible to and generally unobserved by the media content consumer. Thus, detail may be advantageously provided to those media content consumers desiring additional character development while those media content consumers seeking only to enjoy the narrative presentation 102 itself are unencumbered by the inclusion of an inordinate level of character development detail in the narrative presentation 102. The use of supplemental media content presentations 106 at points in a narrative presentation 102 also advantageously provides the production or editing team with opportunities to unobtrusively insert additional artistic material in a narrative presentation 102 without compromising the appeal of the narrative presentation to the broadest possible audience of media content consumers.

A media content consumer accesses the supplemental media content presentations 105 by providing an input to the playback device during the presentation of the narrative presentation 102. Such input may be provided by the media content consumer via a dedicated playback device, a touchscreen, a pointer (e.g., a mouse), a portable electronic device (e.g., a smartphone), or even a remote control device used to control one or more operational aspects of an electronic device. During all or a portion of each of the identified supplemental media content selection periods 105, a number of media content consumer selectable indicators each associated with an aspect of the character's inner awareness are displayed or otherwise presented in the narrative presentation 102. Such selectable indicators may be integrated into the narrative presentation itself, for example by appearing on or proximate the character associated with whom the available supplemental media content presentation 106 is associated. Such selectable indicators may appear external to the narrative presentation 102, for example as icons displayed or presented on a portion of the display device not occupied by the narrative presentation 102. In some instances, one or more display parameters such as the size or aspect ratio of the narrative presentation 102 may be temporarily altered or adjusted to accommodate the display of media content consumer selectable icons on a portion of the display device external to the narrative presentation 102.

Each of the selectable indicators so displayed in the narrative presentation 102 may alert the media content consumer to the presence or availability of a number of supplemental media content presentations 106, each associated with one of a particular cognitive activity, emotional process, or bodily sensation of a character appearing in the narrative scene 104. Such indicators should be sufficiently distinctive that they are readily noticeable, yet should not be so garish as to detract from the narrative presentation 102. The media editing system 100 can therefore provide the production and editing teams with a variety of media content consumer selectable indicators. Additionally, for aesthetic or artistic reasons, the media editing system 100 also provides the production and editing teams with the ability to limit the duration that the media content consumer selectable indicators are displayed in the narrative presentation 102 during each respective supplemental media content selection period 105. For example, a first media content consumer selectable indicator associated with a the cognitive activities of a first character may be displayed for the entirety of the respective supplemental media content selection period 105, while a second media content consumer selectable indicator associated with the emotional processes of a second character may be displayed for only a portion of the respective supplemental media content selection period 105.

Turning to FIG. 1B, the first scene 104a of a narrative presentation 102 is shown. The first scene 104 is comprised of a number of frames 130a-130n (collectively “frames 130”) the progression of which (e.g., at 24 frames per second or 48 frames per second) provides a portion of the narrative presentation 102. A supplemental media content selection period 105a is shown extending for a portion of the first scene 104a, from frame 228 to the conclusion of the scene at frame 728. The selection of the start and end points for the supplemental media content selection period 105a are adjustable and are selected by the production or editing teams based on a number of factors including the temporal relationship between the available supplemental media content presentations 106 and the narrative presentation 102, the presence of the character associated with the supplemental media content presentations 106 in the narrative presentation 102, and intangible or artistic factors such as whether the appearance of the media content consumer selectable indicators would be disruptive to the flow of the narrative presentation 102.

In at least some implementations, a first step in inserting supplemental media content selection period 105a is identifying the presence of the character with which the supplemental media content presentations 106 are associated. In some implementations, the identification of the character within scene 104a may be performed manually by the production or editing teams. In other implementations, the media editing system 100 may include facial or similar anatomical recognition capabilities to facilitate the autonomous identification of characters throughout the narrative presentation 102. In at least some implementations, whether manually or automatically generated, the presence of a character may be displayed graphically by the media editing system 100 on a display device. One example graphically displayed indicator is the presence indicator bar 108a depicted in FIG. 1B. The presence indicator bar 108a provides a visual indication to the system user that character “Alpha” 110 appears throughout the first scene 104a of the narrative presentation 102.

Three supplemental media content presentations 106aa, 106ba, and 106ca are associated with character “Alpha” 110. Supplemental media content presentation 106aa includes additional material on Alpha's cognitive activities associated with events occurring during the supplemental media content selection period 105a in scene 104a. Supplemental media content presentation 106ba includes additional material on Alpha's emotional processes associated with events occurring during the supplemental media content selection period 105a in scene 104a. Supplemental media content presentation 106ca includes additional material on Alpha's instincts or bodily sensations associated with events occurring during the supplemental media content selection period 105a in scene 104a. In at least some implementations, the availability of supplemental media content presentations 106 may be displayed graphically by the media editing system 100. Example graphical indicators include the supplemental media content presentation indicator bars corresponding to supplemental media content presentations 106aa-106ca, respectively, depicted in FIG. 1B. Although the supplemental media content presentation indicator bars indicate the availability of three (3) supplemental media content presentations 106 associated with character Alpha 110 in FIG. 1B, one of ordinary skill in the art would readily appreciate that a greater or lesser number of supplemental media content presentations 106 associated with additional aspects of Alpha's inner awareness could be associated with a character and displayed accordingly by the media editing system 100.

Selectable indicator bars 107aa-107ca (collectively, “selectable indicator bars 107”) are disposed proximate the supplemental media content presentation indicator bars corresponding to supplemental media content presentations 106aa-106ca, respectively. As discussed above, for practical, aesthetic, or artistic reasons, the production and editing teams may decide that providing a visible media content consumer selectable indicator for the duration of the supplemental media content selection period 105a is unacceptable. In such instances, the media content consumer selectable indicator associated with some or all of the available supplemental media content presentations 106 may be visible for only a portion of the supplemental media content selection period 105a. The selectable indicator bars 107aa-107ca indicate the portion of supplemental media content selection period 105a during which the selectable indicator logically associated with the supplemental media content presentation 106aa-106ca is presented to the media content consumer.

The media content consumer selectable indicator 140 logically associated with the cognitive activities of character Alpha 110 is provided as a “halo” or similar visually distinctive effect including color, intensity, contrast, or a combination thereof of the portion of the frame image about Alpha's head area. Such a halo effect may be displayed in a single color, in a number of colors, or with a “shimmer” or similar visual effect made by alternating colors of the halo effect, alternating locations of the halo effect, or combinations thereof. The selectable indicator bar 107aa logically associated with the selectable indicator 140 extends for the full duration of supplemental media content selection period 105a indicating that selectable indicator 140 is visible within the narrative presentation 102 for the full duration of supplemental media content selection period 105a. Thus, selectable indicator 140 appears in the narrative presentation 102 at the outset of supplemental media content selection period 105a at frame 228 and remains visible in the narrative presentation 102 until the conclusion of the supplemental media content selection period 105a at frame 728.

The media content consumer selectable indicator 142 logically associated with the emotional processes of character Alpha 110 is provided as a “halo” or similar visually distinctive effect including color, intensity, contrast, or a combination thereof of the portion of the frame image about Alpha's chest area. Such a halo effect may be displayed in a single color, in a number of colors, or with a “shimmer” or similar visual effect made by alternating colors of the halo effect, alternating locations of the halo effect, or combinations thereof. The selectable indicator bar 107ba logically associated with the selectable indicator 142 extends for about the first two-thirds (⅔) of the duration of supplemental media content selection period 105a indicating that selectable indicator 142 is visible within the narrative presentation 102 for the first two-thirds of the duration of supplemental media content selection period 105a. Thus, selectable indicator 142 appears in the narrative presentation 102 at the outset of supplemental media content selection period 105a at frame 228 and remains visible in the narrative presentation 102 for about the first two-thirds of the supplemental media content selection period 105a, disappearing at frame 563.

The media content consumer selectable indicator 144 logically associated with the instinct, bodily sensations, or “gut feel” of character Alpha 110 is provided as a “halo” or similar visually distinctive effect including color, intensity, contrast, or a combination thereof of the portion of the frame image about Alpha's abdominal area. Such a halo effect may be displayed in a single color, in a number of colors, or with a “shimmer” or similar visual effect made by alternating colors of the halo effect, alternating locations of the halo effect, or combinations thereof. The selectable indicator bar 107ca logically associated with the selectable indicator 144 extends for about the first one-third (⅓) of the duration of supplemental media content selection period 105a indicating that selectable indicator 144 is visible within the narrative presentation 102 for the first one-third of the duration of supplemental media content selection period 105a. Thus, selectable indicator 144 appears in the narrative presentation 102 at the outset of supplemental media content selection period 105a at frame 228 and remains visible in the narrative presentation 102 for about the first one-third of the supplemental media content selection period 105a, disappearing at frame 393.

Turning to FIG. 1C, the third scene 104c of a narrative presentation 102 depicting an interaction between characters “Alpha” and “Beta” is shown. The third scene 104c is comprised of a number of frames 130a-130n the progression of which provides a portion of the narrative presentation 102. Two supplemental media content selection periods 105b and 105c are shown extending for different portions of the third scene 104c. A first supplemental media content selection period 105b is shown extending for a first portion of the third scene 104c, from frame 1375 to frame 1496. A second supplemental media content selection period 105c is shown extending for a second portion of the third scene 104c, from frame 1727 to frame 2112. The selection of the start and end points for the supplemental media content selection periods 105b and 105c are adjustable and are selected by the production or editing teams. During the first supplemental media content selection period 105b, supplemental media content presentations 106ab-106cb each associated with a respective cognitive activity, emotional process, or instinct of character Alpha are made available to the media content consumer. During the second supplemental media content selection period 105c, supplemental media content presentations 106ac-106cc each associated with a respective cognitive activity, emotional process, or instinct of character Beta are made available to the media content consumer.

The presence indicator bar 108b indicates character Alpha is present for the duration of the third scene 104c. Selectable indicator bars 107ab, 107bb, and 107cb, each logically associated with media content consumer selectable indicators 140, 142, and 144, respectively, extend for the duration of the first supplemental media content selection period 105b indicating that all three selectable indicators are visible within the narrative presentation 102 for the duration of the first supplemental media content selection period 105b.

Similarly, the presence indicator bar 108c indicates character Beta is present for the duration of the third scene 104c. Selectable indicator bars 107ac, 107bc, and 107cc, each logically associated with media content consumer selectable indicators 140, 142, and 144, respectively, extend for the duration of the second supplemental media content selection period 105c indicating that all three selectable indicators are visible within the narrative presentation 102 for the duration of the second supplemental media content selection period 105c.

Turning to FIG. 1D, the final scene 104n of a narrative presentation 102 again depicting an interaction between characters “Alpha” and “Beta” is shown. The final scene 104n is comprised of a number of frames 130a-130n the progression of which provides the final of the narrative presentation 102. A single supplemental media content selection period 105d is shown extending for a portion of the final scene 104n. A supplemental media content selection period 105d is shown extending from frame 8881 to frame 9000. The selection of the start and end points for the supplemental media content selection period 105d is adjustable and is selected by the production or editing teams. During the supplemental media content selection period 105d, supplemental media content presentations 106ad-106cd each associated with a respective cognitive activity, emotional process, or instinct of character Alpha are made available to the media content consumer. Additionally, during the supplemental media content selection period 105d supplemental media content presentations 106ae-106ce each associated with a respective cognitive activity, emotional process, or instinct of character Beta are also made available to the media content consumer.

The presence indicator bar 108d indicates character Alpha is present for the duration of the final scene 104n. Selectable indicator bars 107ad, 107bd, and 107cd, each logically associated with media content consumer selectable indicators 140, 142, and 144, respectively, extend for the duration of supplemental media content selection period 105d indicating that all three selectable indicators are visible within the narrative presentation 102 for the duration of supplemental media content selection period 105d.

The presence indicator bar 108e indicates character Beta is present for only a latter portion of the final scene 104d. Selectable indicator bars 107ae, 107be, and 107ce, each logically associated with media content consumer selectable indicators 140, 142, and 144, respectively, extend for the duration of supplemental media content selection period 105d indicating that all three selectable indicators are visible within the narrative presentation 102 for the duration of supplemental media content selection period 105d.

When, as depicted in FIG. 1D, supplemental media content presentations 106 are available for multiple characters, the media editing system 100 provides the production or editing teams with the ability to specify the order in which the supplemental media content presentations 106 are provided to the media content consumer. For example, the media content consumer may, over a short interval of time, select a number of supplemental media content presentations 106 in a consecutive order. In some instances, the supplemental media content presentations 106 are presented in an order corresponding to the selection order of the media content consumer. In other instances, the production or editing teams may specify in the media editing system 100 that all of the supplemental media content presentations 106 associated with a first character be viewed prior to providing selectable indicators associated with supplemental media content presentations 106 for other characters. In yet other instances, the production or editing teams may specify that a first type of supplemental media content presentations 106 (e.g., all supplemental media content presentations associated with cognitive activities, emotional processes, or instinct) for every character must be viewed prior to providing selectable indicators for other types of supplemental media content presentations 106. In yet other instances, the production or editing teams may designate certain supplemental media content presentations 106 as “premium content” requiring an additional fee or purchase of additional items to “unlock” (e.g., through the input of a code or “key” by the media content consumer) the selectable indicators associated with such supplemental media content presentations 106.

FIGS. 2A, 2B, and 2C each show example media content consumer selectable indicator types. One or more media content consumer indicators appear during each of the supplemental media content selection periods 105 to indicate to the media content consumer the availability of a logically associated supplemental media content presentation 106 that is associated with at least one aspect of a character's inner awareness. As discussed in detail above, such inner awareness is exemplified by, although not limited to, a character's cognitive activities, a character's emotional processes, or a character's instinct, intuition, or bodily sensations. The media content consumer selectable indicators appearing in the narrative presentation 102 may be directly selectable (e.g., permitting a content consumer to select the indicator by pressing the indicator on a touchscreen or “clicking” on the indicator using a pointing device such as a mouse). The media content consumer indicators appearing in the narrative presentation 102 may indicate the presence of a selectable region within the narrative presentation 102 (e.g., indicating a selectable region logically associated with the selectable indicator located remote from the selectable indicator).

The media editing system 100 can provide any number or type of media content consumer selectable indicators for placement in the narrative presentation 102 during at least a portion of the supplemental media content selection periods 105.

In at least some narrative presentations, such as the fantasy narrative presentation 102 depicted in FIG. 2A, at least a portion of the media content consumer selectable indicators can include one or more colors, features, or effects displayed about or proximate at least a portion of the representation of the character with which the supplemental media content presentation 106 is associated as depicted in FIG. 2A. Such selectable indicators may include distinctive colors or effects that appear about a portion of the character associated with the particular aspect of inner awareness. In some instances, a distinctive color or effect may appear as a “halo” or similar translucent or partially transparent feature about a character's head area 140 to indicate the availability of a supplemental media content presentation 106 associated with a cognitive activity (i.e., “brain”) of the character; about a character's chest area 142 to indicate the availability of a supplemental media content presentation 106 associated with an emotional process (i.e., “heart”) of the character; and about a character's abdominal area 144 to indicate the availability of a supplemental media content presentation 106 associated with an intuition, instinct, or bodily sensation (i.e., “gut”) of the character. In at least some implementations, the distinctive color or effect about a character may be reduced, minimized, or completely eliminated to designate the supplemental media content presentation 106 associated with the particular selectable indicator as having been previously viewed by the media content consumer during the current instance of the narrative presentation 102.

In other narrative presentations, such as the dramatic narrative presentation depicted in FIG. 2B, at least a portion of the media content consumer selectable indicators can include one or more distinctive icons displayed about or proximate at least a portion of the representation of the character with which the supplemental media content presentation 106 is associated. In at least some implementations, such distinctive icons may include an image of a brain 202 to indicate a character's cognitive activity or thoughts; a heart 204 to indicate a character's emotional process or emotions; and a stomach 206 to indicate a character's intuition, instinct, or bodily sensation.

In at least some instances, a halo or similar color or visual effect may be placed on, about, or proximate each icon to indicate previously unviewed supplemental media content presentations 106 to the media content consumer. For example a halo disposed about a brain 212 indicates a previously unviewed supplemental media content presentation 106 associated with the cognitive activities of character 216 and similarly, a halo disposed about a heart 214 indicates a previously unviewed supplemental media content presentation 106 associated with the cognitive activities of character 216. In such instances, the halo, color, distinctive visual effect may be reduced, minimized, or completely eliminated to designate the supplemental media content presentation 106 associated with the particular selectable indicator as having been previously viewed by the media content consumer during the current instance of the narrative presentation 102.

In yet other narrative presentations, such as the animated narrative presentation depicted in FIG. 2C, at least a portion of the media content consumer selectable indicators can include one or more distinctive icons displayed remote from the characters or remote from the narrative presentation 102. In at least some instances, such distinctive icons may include an image of a brain 222 to indicate a character's cognitive activity or thoughts; a heart 224 to indicate a character's emotional process or emotions; and a stomach 226 to indicate a character's intuition, instinct, or bodily sensation. The distinctive icons can be displayed in a region of the display device that is proximate an image or other representation 230, 240 of the character associated with each of the respective supplemental media content presentations 106 logically associated with each of the distinctive icons 222, 224, and 226.

In at least some instances, a halo or similar color or visual effect or other status designator may be placed on, about, or proximate each icon to indicate previously unviewed supplemental media content presentations 106 to the media content consumer. In such instances, the halo, color, distinctive visual effect or other status designator may be reduced, minimized, or completely eliminated to designate the supplemental media content presentation 106 associated with the particular selectable indicator as having been previously viewed by the media content consumer during the current instance of the narrative presentation 102.

FIG. 3 shows a supplemental media content presentation 106 consisting of a number of scenes 304a-304n and two subordinate supplemental media content presentations 306a and 306aa (collectively “subordinate supplemental media content presentations 306), each consisting of a number of defined scenes 314a-314n (collectively “scenes 314”). Subordinate supplemental media content presentation 306a provides additional detail, insight or information on one or more aspects of an inner awareness (e.g., cognitive activities, emotional processes, intuition, instinct or bodily sensations) associated with a character included in the supplemental media content presentation 106. Subordinate supplemental media content presentation 306aa provides additional detail, insight or information on one or more aspects of an inner awareness (e.g., cognitive activities, emotional processes, intuition, instinct or bodily sensations) associated with a character included in the supplemental media content presentation 306a. Additional levels of “nested” subordinate supplemental media content presentations, each providing information on one or more aspects of the inner awareness of a character included in the prior subordinate supplemental media content presentation, may also be created.

Characters appearing within the subordinate supplemental media content presentations 306 may include characters that have or will be included in the narrative presentation 102, and may also include any number of characters that are unique to each of either the supplemental media content presentation 106 or subordinate supplemental media content presentations 306.

One or more subordinate supplemental media content selection periods 305a-305n (collectively “subordinate supplemental media content selection periods 305”) are identified by the production or editing teams using the media editing system 100. Similarly, one or more subordinate supplemental media content selection periods 305 are identified in each of the subordinate supplemental media content presentations 306. Media content consumer selectable indicators, each associated with an aspect of an inner awareness of a character included in the supplemental media content presentation 106 or the subordinate supplemental media content presentations 306 are inserted into the supplemental media content presentation 106 or the subordinate supplemental media content presentations 306 to alert the media content consumer to the availability of additional media content regarding the respective character's cognitive activities, emotional processes, intuition, instinct or bodily sensations.

Supplemental media content presentation 106 includes one subordinate supplemental media content selection period 305a in the first scene 304a. The presence indicator bar 308a provides an indication to the system user that supplemental media content character Gamma is present from the outset of scene 304a to the conclusion of the subordinate supplemental media content selection period 305a. The presence of character Gamma in the supplemental media content presentation 106 can be detected manually or autonomously by the media editing system 100 using one or more facial or similar anatomical recognition routines. Three subordinate supplemental media content presentations 306a-306c are associated with character Gamma, 306a is associated with Gamma's thought process during scene 304a, 306b is associated with Gamma's emotional process during scene 304a, and 306c is associated with Gamma's intuition or instincts during scene 304a. Media content consumer selectable indicators, each logically associated with one of the three subordinate supplemental media content presentations 306a, 306b, and 306c will appear in the supplemental media content presentation 106 during the subordinate supplemental media content selection period 305a. Selection of one of the media content consumer selectable indicators in the supplemental media content presentation 106 will open and initiate the presentation of subordinate supplemental media content presentation 306a to the media content consumer.

Subordinate supplemental media content presentation 306a includes one subordinate supplemental media content selection period 305aa in the first scene 314a. The presence indicator bar 318 provides an indication to the system user that supplemental media content character Delta is present in scene 314a for the duration of the subordinate supplemental media content selection period 305aa. The presence of character Delta in the subordinate supplemental media content presentation 306a can be detected manually or autonomously by the media editing system 100 using one or more facial or similar anatomical recognition routines. A single subordinate supplemental media content presentations 306aa is associated with character Delta, 306aa is associated with Delta's thought process during scene 314a. A media content consumer selectable indicator logically associated with subordinate supplemental media content presentation 306aa will appear in the supplemental media content presentation 306a during the subordinate supplemental media content selection period 305aa. Selection of one of the media content consumer selectable indicators in the supplemental media content presentation 306a will open and initiate the presentation of subordinate supplemental media content presentation 306aa.

Supplemental media content presentation 306aa includes one subordinate supplemental media content selection period 305aaa in the first scene 314a. The presence indicator bar 328 provides an indication to the system user that supplemental media content character Epsilon is present in scene 314a for the duration of the subordinate supplemental media content selection period 305aaa. The presence character Epsilon in the subordinate supplemental media content presentation 306aa can be detected manually or autonomously by the media editing system 100 using one or more facial or similar anatomical recognition routines. A single subordinate supplemental media content presentation 306aaa is associated with Epsilon's thought process in scene 314a during the subordinate supplemental media content presentation 305aaa. A media content consumer selectable indicator that is logically associated with and used by the media content consumer to access subordinate supplemental media content presentation 306aaa will appear in the supplemental media content presentation 306aaa during the subordinate supplemental media content selection period 305aaa. Selection of the media content consumer selectable indicator appearing in subordinate supplemental media content presentation 306aa will open and initiate the presentation of subordinate supplemental media content presentation 306aaa.

One of ordinary skill in the art will readily appreciate the ability to “nest” any number of subordinate supplemental media content presentations within other subordinate supplemental media content presentations. At the conclusion of each of the subordinate supplemental media content presentations 306, the media editing system 100 may be used to identify a temporal return point in an earlier subordinate supplemental media content presentation 306, the supplemental media content presentation 106, or the narrative presentation 102 to which the media content consumer is returned. The media editing system 100 is used by production and editing teams to identify and insert one or more transition modes between the narrative presentation 102 and the supplemental media content presentation 106 as well as between the supplemental media content presentation 106 and any number of subordinate supplemental media content presentations 306.

FIG. 4 shows various return options for transitioning between a supplemental media content presentation 106 back to a narrative presentation 102 or transitioning between a subordinate supplemental media content presentation 306 back to a supplemental media content presentation 106. An illustrative narrative presentation 102 including a scene 104 starting at the left and comprising a number of frames 130a-130g is shown progressing from left to right as a function of time 401. In the frames 130, an adult 402 is seen playing catch with a child 404. A first media content consumer selectable indicator including a halo about the adult's head area indicates the availability of a supplemental media content presentation 106 associated with the cognitive activities of the adult 402. A second media content consumer selectable indicator including a halo about the adult's chest area indicates the availability of a supplemental media content presentation 106 associated with the emotional processes of the adult 402.

When a media content consumer provides an input indicative of a desire to access the supplemental media content presentation 106 associated with the cognitive activities of the adult 402 (e.g., at frame 130d, time “t₁”) the supplemental media content presentation logically associated with the cognitive activities 140 of the adult will be presented. At the conclusion of the supplemental media content presentation 106, the narrative presentation 102 will be rejoined. The media editing system 100 can provide a number of possible temporal relationships for rejoining the narrative presentation 102 from a supplemental media content presentation 106 or for rejoining the supplemental media content presentation 106 from a subordinate supplemental media content presentation 306. The production or editing teams may select one or more of the possible temporal relationships based on artistic direction and maintaining a desired “flow” in the rejoined presentation.

In at least some instances, the production or editing teams can elect to have the narrative presentation 102 or supplemental media content presentation 106 rejoined at the same temporal point (e.g., t₁) 420 as the time of departure from the narrative presentation 102 or supplemental media content presentation 106. Such allows the narrative presentation 102 or supplemental media content presentation 106 to “pick up where we left off.” In other instances, the production and editing teams can elect to have the narrative presentation 102 or supplemental media content presentation 106 rejoined at the beginning of the scene 104 (e.g., t₂) 422. In yet other instances, the production or editing teams can elect to have the narrative presentation 102 or supplemental media content presentation 106 rejoined at a defined earlier temporal point (e.g., t₃) 424 that precedes the time of departure from the narrative presentation 102 or supplemental media content presentation 106 by a defined amount of time. The defined amount of time may be determined by the production or editing teams to permit a degree of coherence or “flow” to the rejoined narrative presentation 102 or supplemental media content presentation 106. For example, the defined amount of time may be provided as an input 426 to the media editing system 100 by the production or editing teams.

The media editing system 100 can also provide the production or editing teams with a variety of options for the narrative presentation 102 while a supplemental media content presentation 106 is being presented and for the supplemental media content presentation 106 when a subordinate supplemental media content presentation 306 is being presented. In at least some instances, the production or editing teams may elect to have the narrative presentation 102 or the supplemental media content presentation 106 stop (e.g., be interrupted) when a supplemental media content presentation 106 or a subordinate supplemental media content presentation 306, respectively, is presented to the media content consumer. In other instances, the production or editing teams may elect to have the narrative presentation 102 or the supplemental media content presentation 106 progress or advance at a defined lower frame rate (e.g., 6 or 12 frames per second rather than 24 or 48 frames per second) when a supplemental media content presentation 106 or a subordinate supplemental media content presentation 306, respectively, is presented to the media content consumer. In yet other instances, the production or editing teams may elect to have a defined number of frames 130 (e.g., 96 or 192 frames) of the narrative presentation 102 or the supplemental media content presentation 106 “loop” when a supplemental media content presentation 106 or a subordinate supplemental media content presentation 306, respectively, is presented to the media content consumer.

The point at which the narrative presentation 102 or the supplemental media content presentation 106 is rejoined may be determined at least in part autonomously by the media editing system 100. For example, if the production or editing teams elect to have the narrative presentation 102 or supplemental media content presentation 106 “loop” while the supplemental media content presentation 106 or subordinate supplemental media content presentation 306 is presented, the media editing system 100 may automatically rejoin the narrative presentation 102 or supplemental media content presentation 106 at the first frame of the loop.

In another instances, the point at which the narrative presentation 102 or the supplemental media content presentation 106 is rejoined may be determined at least in part based on the temporal point of departure from the narrative presentation 102 or the supplemental media content presentation 106. For example, the media content consumer may depart the narrative presentation 102 or the supplemental media content presentation 106 near the end of a supplemental media content selection period 105 or the end of the scene 104. In such instances, the media editing system 100 may automatically return to the beginning of the supplemental media content selection period 105 or the beginning of the scene 104.

In at least some implementations, the appearance or state of the media content selectable indicators in the narrative presentation 102 may be altered responsive to the selection of the indicator by the media content consumer. For example, in some instances once a supplemental media content presentation 106 has been viewed, the media content consumer selectable indicator logically associated with the supplemental media content presentation 106 may change appearance or may disappear entirely. In other implementations, the state of the media content consumer selectable indicator may be changed from a selectable state to a non-selectable state. Such a change in appearance or in state of the media content consumer selectable indicator may occur at the temporal point of departure in the narrative presentation 102 or at the temporal point at which the narrative presentation 102 is rejoined. For example as depicted in FIG. 4, the appearance of the media content consumer selectable indicator logically associated with the cognitive activities of the adult 402 can be altered (e.g., removed) from the narrative presentation 102 at the temporal point of departure in scene 130d.

FIGS. 5A and 5B show various transition methods from a narrative presentation 102 to a supplemental media content presentation 106, according to one or more embodiments. The transitions described herein with respect to the narrative presentation 102 and the supplemental media content presentation 106 and back to the narrative presentation 102 may also be used to transition from a supplemental media content presentation 106 to a subordinate supplemental media content presentation 306 and back to the supplemental media content presentation 106. FIG. 5A shows a first transition mode in which the relative sizes of the narrative presentation 102 and the supplemental media content presentation 106 are “swapped.” The narrative presentation 102 is reduced in display area from 502a to 502b while the supplemental media content presentation 106 is contemporaneously increased in display area from 504a to 504b. Although shown as having the same size, the enlarged narrative presentation 102 and the enlarged supplemental media content presentation 106 can have different sizes with either being larger or smaller than the other. FIG. 5B shows another transition mode where the display area of the narrative presentation 102 is reduced in brightness or intensity from 502a to 502b when the supplemental media content presentation 106 is provided in display area 504b.

FIG. 6 shows a high-level method of editing a narrative presentation 102 consisting of a defined number of scenes in a defined sequence to include any number of supplemental media content presentations 106. Such supplemental media content presentations 106 may be used by the production or editing teams to provide the media content consumer with access to information on one or more aspects of a character's inner awareness. The supplemental media content presentations 106 provide the opportunity for media content consumers desiring more information about a character to access such information in the form of a supplemental media content presentation 106. Such supplemental media content presentations 106 may contain fictional or non-fictional information on one or more aspects of a narrative character's inner awareness. Such supplemental media content presentations 106 may also be associated with animated or other media targeting children, and may contain educational or informational subject matter associated with a character (e.g., a supplemental media content presentation 106 associated with the flying elephant character “Dumbo” may contain information on actual elephants). The method commences at 602.

At 604, the production or editing teams identify a number of supplemental media content selection periods 105 in the narrative presentation 102. The supplemental media content selection periods 105 identify portions of the narrative presentation where one or more supplemental media content presentations 106 are logically associated with a narrative character appearing in the narrative. Such supplemental media content selection periods 105 may extend for an entire scene of a narrative or may extend for only a portion of a scene.

At 606, the production or editing teams insert a number of media content consumer selectable indicators into the narrative presentation 102 to indicate those narrative characters with which at least one supplemental media content presentation 106 is associated. The media content consumer selectable indicators may include visible effects distinguishing the narrative character with which the supplemental media content presentation 106 is associated. The media content consumer selectable indicators may include selectable icons (e.g., JPEG, GIF, TIFF images) that are logically associated with a supplemental media content presentation 106 associated with the particular character appearing in the narrative presentation. Such selectable icons may be positioned proximate the narrative character or associated with an image or other representation of the narrative character. The use of media content consumer selectable indicators that are available only during supplemental media content selection periods 105 identified in the narrative presentation 102 permits the production and editing teams to provide supplemental media content presentations 106 that are temporally relevant and contextually related to the narrative character appearing in the narrative presentation 102 during the supplemental media content selection period 105.

At 608, the production and editing teams can select one of a number of transition modes to transition between the narrative presentation 102, the supplemental media content presentation 106, and back to the narrative presentation 102. One such transition mode may include contemporaneously adjusting the size of the display area of both the narrative presentation 102 and the supplemental media content presentation 106. Another such transition mode may include reducing the brightness or intensity of the narrative presentation 102 (e.g., fading the narrative presentation) when transitioning from the narrative presentation 102 to the supplemental media content presentation 106 and increasing the brightness or intensity of the narrative presentation when transitioning from the supplemental media content presentation 106 back to the narrative presentation 102. The method concludes at 610.

FIG. 7 shows a high-level method of providing any number of supplemental media content presentations 106 during each of the supplemental media content selection periods 105 identified in a narrative presentation 102, according to one or more embodiments. Within each of the supplemental media content selection periods 105 in the narrative presentation 102, narrative characters may appear in a defined number and sequence of scenes 104 forming the narrative presentation 102. The production or editing teams may desire to provide additional information associated with one or more characters included in the narrative presentation 102. Such additional material associated with a character appearing in the narrative presentation 102 is provided in a subordinate supplemental media content presentation 106 that is logically related to the narrative presentation 102. The method commences at 702.

At 704, the production or editing teams identify a number of supplemental media content selection periods 105 in the narrative presentation 102. The supplemental media content selection periods 105 identify portions of the narrative presentation where one or more supplemental media content presentations 106 are logically associated with a narrative character appearing in the narrative. Such supplemental media content selection periods 105 may extend for an entire scene of a narrative or may extend for only a portion of a scene.

At 706, the production or editing teams insert a number of media content consumer selectable indicators into the narrative presentation 102 to indicate those narrative characters with which at least one supplemental media content presentation 106 is associated. The media content consumer selectable indicators may include visible effects distinguishing the narrative character with which the supplemental media content presentation 106 is associated. The media content consumer selectable indicators may include selectable icons (e.g., JPEG, GIF, TIFF images) that are logically associated with a supplemental media content presentation 106 associated with the particular character appearing in the narrative presentation. Such selectable icons may be positioned proximate the narrative character or associated with an image or other representation of the narrative character. The use of media content consumer selectable indicators that are available only during supplemental media content selection periods 105 identified in the narrative presentation 102 permits the production and editing teams to provide supplemental media content presentations 106 that are temporally relevant and contextually related to the narrative character appearing in the narrative presentation 102 during the supplemental media content selection period 105.

At 708, the production and editing teams can select one of a number of transition modes to transition between the narrative presentation 102, the supplemental media content presentation 106, and back to the narrative presentation 102. One such transition mode may include contemporaneously adjusting the size of the display area of both the narrative presentation 102 and the supplemental media content presentation 106. Another such transition mode may include reducing the brightness or intensity of the narrative presentation 102 (e.g., fading the narrative presentation) when transitioning from the narrative presentation 102 to the supplemental media content presentation 106 and increasing the brightness or intensity of the narrative presentation when transitioning from the supplemental media content presentation 106 back to the narrative presentation 102. Other transition modes are possible and may be defined by the production or editing teams.

The production and editing teams can also select one or more standby modes into which the narrative presentation 102 enters when a supplemental media content presentation 106 is presented to the media content consumer. One possible standby mode includes “freezing” the narrative presentation 102 at the temporal point of departure from the narrative presentation 102 to the supplemental media content presentation 106. Another possible standby mode includes looping a defined number of frames 130 in the scene 104 of the narrative presentation 102 about the temporal point of departure from the narrative presentation 102 to the supplemental media content presentation 106. Other standby modes are possible and may be defined by the production or editing teams. In at least some implementations, the audio output level or sound of a narrative presentation placed into a standby “looping” mode or a standby reduced frame rate mode may be decreased. In at least some implementations, the audio output level or sound of the narrative presentation placed into a standby “looping” mode or a standby reduced frame rate mode may be inhibited (e.g., reduced to “zero” audio output level or sound).

At 710, the production or editing teams identify a temporal relationship between the supplemental media content presentation 106 and the narrative presentation 102. One possible temporal relationship may include rejoining the narrative presentation 102 from the supplemental media content presentation 106 at the temporal departure point from the narrative presentation 102. Another possible temporal relationship may include rejoining the narrative at the first frame of a defined repeating loop of narrative frames about the temporal departure point from the narrative presentation 102. In at least some instances, the media editing system 100 can automatically define temporal relationship of rejoining at the first frame of a defined loop of narrative frames when the corresponding narrative standby mode is selected by the production or editing teams. Another possible temporal relationship is rejoining the narrative presentation 102 at a temporal point a defined time or a defined number of frames prior to the temporal departure point from the narrative presentation 102. Other temporal relationships are possible and may be defined by the production or editing teams. The method 700 concludes at 712.

FIG. 8 shows a high-level method of providing a number of nested subordinate supplemental media content presentation 306 in each of the supplemental media content presentation 106 logically associated with a narrative presentation 102, according to one or more embodiments. Within each of the supplemental media content presentations 106 associated with a particular narrative presentation, narrative characters and other characters not included in the narrative may appear in a defined number and sequence of scenes forming the supplemental media content presentation 106. The production or editing teams may desire to provide additional information associated with one or more characters included in the supplemental media content presentation 106. Such additional material associated with a character appearing in a supplemental media content presentation 106 is provided in a subordinate supplemental media content presentation 306 that is logically related to the supplemental media content presentation 106 which, in turn, is related to the narrative presentation 102. Multiple “levels” of nested subordinate supplemental media content presentations 306 (i.e., subordinate supplemental media content presentation 306 that are logically associated with another subordinate supplemental media content presentation 306 rather than a supplemental media content presentation 106) may be defined by the production or editing teams. The method commences at 802.

At 804, the production or editing teams identify a number of supplemental media content selection periods 105 in the narrative presentation 102. The supplemental media content selection periods 105 identify portions of the narrative presentation where one or more supplemental media content presentations 106 are logically associated with a narrative character appearing in the narrative. Such supplemental media content selection periods 105 may extend for an entire scene of a narrative or may extend for only a portion of a scene.

At 806, the production or editing teams insert a number of media content consumer selectable indicators into the narrative presentation 102 to indicate those narrative characters with which at least one supplemental media content presentation 106 is associated. The media content consumer selectable indicators may include visible effects distinguishing the narrative character with which the supplemental media content presentation 106 is associated. The media content consumer selectable indicators may include selectable icons (e.g., JPEG, GIF, TIFF images) that are logically associated with a supplemental media content presentation 106 associated with the particular character appearing in the narrative presentation. Such selectable icons may be positioned proximate the narrative character or associated with an image or other representation of the narrative character. The use of media content consumer selectable indicators that are available only during supplemental media content selection periods 105 identified in the narrative presentation 102 permits the production and editing teams to provide supplemental media content presentations 106 that are temporally relevant and contextually related to the narrative character appearing in the narrative presentation 102 during the supplemental media content selection period 105.

At 808, the production and editing teams can select one of a number of transition modes to transition between the narrative presentation 102, the supplemental media content presentation 106, and back to the narrative presentation 102. One such transition mode may include contemporaneously adjusting the size of the display area of both the narrative presentation 102 and the supplemental media content presentation 106. Another such transition mode may include reducing the brightness or intensity of the narrative presentation 102 (e.g., fading the narrative presentation) when transitioning from the narrative presentation 102 to the the supplemental media content presentation 106 and increasing the brightness or intensity of the narrative presentation when transitioning from the supplemental media content presentation 106 back to the narrative presentation 102. Other transition modes are possible and may be defined by the production or editing teams.

The production and editing teams can also select one or more standby modes into which the narrative presentation 102 enters when a supplemental media content presentation 106 is presented to the media content consumer. One possible standby mode includes “freezing” the narrative presentation 102 at the temporal point of departure from the narrative presentation 102 to the supplemental media content presentation 106. Another possible standby mode includes looping a defined number of frames 130 in the scene 104 of the narrative presentation 102 about the temporal point of departure from the narrative presentation 102 to the supplemental media content presentation 106. Other standby modes are possible and may be defined by the production or editing teams.

At 810, the production or editing teams identify a temporal relationship between the supplemental media content presentation 106 and the narrative presentation 102. One possible temporal relationship may include rejoining the narrative presentation 102 from the supplemental media content presentation 106 at the temporal departure point from the narrative presentation 102. Another possible temporal relationship may include rejoining the narrative at the first frame of a defined repeating loop of narrative frames about the temporal departure point from the narrative presentation 102. In at least some instances, the media editing system 100 can automatically define temporal relationship of rejoining at the first frame of a defined loop of narrative frames when the corresponding narrative standby mode is selected by the production or editing teams. Another possible temporal relationship is rejoining the narrative presentation 102 at a temporal point a defined time or a defined number of frames prior to the temporal departure point from the narrative presentation 102. Other temporal relationships are possible and may be defined by the production or editing teams.

At 812, the production or editing teams identify a number of subordinate supplemental media content selection periods 306 in the supplemental media content presentation 106. The supplemental media content presentation 106 consists of a defined number of scenes 304 in a defined order, and each of the subordinate supplemental media content selection periods 306 can include any number of frames within a particular scene 304 of the supplemental media content presentation 106.

At 814, the production or editing teams insert any number of media content consumer selectable indicators into each of the identified subordinate supplemental media content selection periods 306. Each of the media content consumer selectable indicators is associated with an aspect of inner knowledge (cognitive activity, emotional processes, intuition, instinct, or bodily perception) of a character appearing in the supplemental media content presentation 106. Characters associated with one or more media content consumer selectable indicators in the supplemental media content presentation 106 can be identified manually by the production or editing teams or autonomously by the media editing system 100 using facial recognition or similar automated anatomical recognition algorithms. In at least some instances, the media content consumer selectable indicators may be altered in appearance or state after the media content consumer has viewed the subordinate supplemental media content presentation 306 associated with the respective media content consumer selectable indicator. In at least some instances, the change in state of the media content consumer selectable indicators may alter the selectable property of the indicator, rendering the indicator non-selectable for at least the current instance of the narrative presentation 102.

At 816, the production and editing teams can select one of a number of transition modes to transition between the supplemental media content presentation 106, the subordinate supplemental media content presentation 306, and back to the supplemental media content presentation 106. One such transition mode may include contemporaneously adjusting the size of the display area of both the supplemental media content presentation 106 and the subordinate supplemental media content presentation 306. Another such transition mode may include reducing the brightness or intensity of the supplemental media content presentation 106 (e.g., fading the supplemental media content presentation) when transitioning from the supplemental media content presentation 106 to the subordinate supplemental media content presentation 306 and increasing the brightness or intensity of the supplemental media content presentation 106 when transitioning from the subordinate supplemental media content presentation 306 back to the supplemental media content presentation 106. Other transition modes are possible and may be defined by the production or editing teams.

The production and editing teams can also select one or more standby modes into which the supplemental media content presentation 106 is placed when a subordinate supplemental media content presentation 306 is presented to the media content consumer. One possible standby mode includes “freezing” the supplemental media content presentation 106 at the temporal point of departure from the supplemental media content presentation 106 to the subordinate supplemental media content presentation 306. Another possible standby mode includes looping a defined number of frames 130 in the scene 304 of the supplemental media content presentation 106 about the temporal point of departure from the supplemental media content presentation 106 to the subordinate supplemental media content presentation 306. Other standby modes are possible and may be defined by the production or editing teams.

At 818, the production or editing teams identify a temporal relationship between the subordinate supplemental media content presentation 306 and the subordinate supplemental media content presentation 306. One possible temporal relationship may include rejoining the supplemental media content presentation 106 from the subordinate supplemental media content presentation 306 at the temporal departure point from the supplemental media content presentation 106. Another possible temporal relationship may include rejoining the supplemental media content presentation 106 at the first frame of a defined repeating loop of frames 130 about the temporal departure point from the supplemental media content presentation 106. In at least some instances, the media editing system 100 can automatically define temporal relationship of rejoining at the first frame of a defined loop of frames 130 when the corresponding standby mode is selected by the production or editing teams. Another possible temporal relationship is rejoining the supplemental media content presentation 106 at a temporal point a defined time or a defined number of frames prior to the temporal departure point from the supplemental media content presentation 106. Other temporal relationships are possible and may be defined by the production or editing teams. The method 800 concludes at 820.

FIG. 9 shows a high-level method of providing any number of supplemental media content presentations 106 associated with two or more characters included in a narrative presentation 102 during a single supplemental media content selection period 105, according to one or more embodiments. Within each of the supplemental media content selection periods 105 in the narrative presentation 102, two or more narrative characters may appear in a defined number and sequence of scenes 104 forming the narrative presentation 102. The production or editing teams may desire to provide additional information associated with two or more characters included in the narrative presentation 102. Responsive to the availability of supplemental media content presentation 106 for multiple characters appearing in the narrative presentation 102, the media content consumer may select multiple supplemental media content presentations 106, for example as a series of touchscreen or pointer inputs. The media editing system 100 provides the production and editing teams with a variety of options for presenting each of multiple supplemental media content presentations 106 selected by the media content consumer. The method commences at 902.

At 904, the production or editing teams identify a number of supplemental media content selection periods 105 in the narrative presentation 102. The supplemental media content selection periods 105 identify portions of the narrative presentation where one or more supplemental media content presentations 106 are logically associated with a narrative character appearing in the narrative. Such supplemental media content selection periods 105 may extend for an entire scene of a narrative or may extend for only a portion of a scene.

At 906, the production or editing teams insert a number of media content consumer selectable indicators into the narrative presentation 102 to indicate those narrative characters with which at least one supplemental media content presentation 106 is associated. The media content consumer selectable indicators may include visible effects distinguishing the narrative character with which the supplemental media content presentation 106 is associated. The media content consumer selectable indicators may include selectable icons (e.g., JPEG, GIF, TIFF images) that are logically associated with a supplemental media content presentation 106 associated with the particular character appearing in the narrative presentation. Such selectable icons may be positioned proximate the narrative character or associated with an image or other representation of the narrative character. The use of media content consumer selectable indicators that are available only during supplemental media content selection periods 105 identified in the narrative presentation 102 permits the production and editing teams to provide supplemental media content presentations 106 that are temporally relevant and contextually related to the narrative character appearing in the narrative presentation 102 during the supplemental media content selection period 105.

At 908, the production and editing teams can select one of a number of transition modes to transition between the narrative presentation 102, the supplemental media content presentation 106, and back to the narrative presentation 102. One such transition mode may include contemporaneously adjusting the size of the display area of both the narrative presentation 102 and the supplemental media content presentation 106. Another such transition mode may include reducing the brightness or intensity of the narrative presentation 102 (e.g., fading the narrative presentation) when transitioning from the narrative presentation 102 to the supplemental media content presentation 106 and increasing the brightness or intensity of the narrative presentation when transitioning from the supplemental media content presentation 106 back to the narrative presentation 102. Other transition modes are possible and may be defined by the production or editing teams.

The production and editing teams can also select one or more standby modes into which the narrative presentation 102 enters when a supplemental media content presentation 106 is presented to the media content consumer. One possible standby mode includes “freezing” the narrative presentation 102 at the temporal point of departure from the narrative presentation 102 to the supplemental media content presentation 106. Another possible standby mode includes looping a defined number of frames 130 in the scene 104 of the narrative presentation 102 about the temporal point of departure from the narrative presentation 102 to the supplemental media content presentation 106. Other standby modes are possible and may be defined by the production or editing teams.

At 910, the production or editing teams identify a temporal relationship between the supplemental media content presentation 106 and the narrative presentation 102. One possible temporal relationship may include rejoining the narrative presentation 102 from the supplemental media content presentation 106 at the temporal departure point from the narrative presentation 102. Another possible temporal relationship may include rejoining the narrative at the first frame of a defined repeating loop of narrative frames about the temporal departure point from the narrative presentation 102. In at least some instances, the media editing system 100 can automatically define temporal relationship of rejoining at the first frame of a defined loop of narrative frames when the corresponding narrative standby mode is selected by the production or editing teams. Another possible temporal relationship is rejoining the narrative presentation 102 at a temporal point a defined time or a defined number of frames prior to the temporal departure point from the narrative presentation 102. Other temporal relationships are possible and may be defined by the production or editing teams.

At 912, the production or editing teams identify a presentation sequence when multiple media content consumer selectable indicators each associated supplemental media content presentations 106 for at least two characters are selected. The media content consumer can provide input in a variety of formats dependent upon the capabilities of the playback or display device upon which the narrative presentation 102 is presented. For example, on a playback or display device equipped with a touchscreen, tapping, swiping, or multi-touch input may be configured to correspond to different display options such as the size or location of the supplemental media content presentation 106 on the display device. On playback or display devices equipped with pointers such as a mouse or infrared input device, the movement of the pointer on the display device or in relation to the display device may be configured by the production or editing teams to correspond to different display options such as the size or location of the supplemental media content presentation 106 on the display device. Other input methods are possible and may be defined by the production or editing teams.

In at least some instances, the media content consumer may provide a sequence of inputs, each input in the sequence corresponding to a supplemental media content presentation 106 selection. In such instances, the production or editing teams may define a presentation sequence for each of the supplemental media content presentations 106 selected by the media content consumer. One presentation option is for the presentation sequence to match the input sequence by the media content consumer. For example, a consumer may select supplemental media content presentations 106 associated with (in order): the thought activities of character “B;” the emotional processes of character “C;” and the instinct or intuition of character “A.” Where the input sequence provided by the media content consumer provides the supplemental media content presentation 106 presentation sequence, the media content consumer would be presented with a supplemental media content presentation 106 logically associated with the thought activities of character “B;” a supplemental media content presentation 106 logically associated with the emotional processes of character “C;” followed by a supplemental media content presentation 106 logically associated with the instinct or intuition of character “A.”

Another presentation option is a presentation sequence requiring the media content consumer to view all of the supplemental media content presentations 106 logically associated with a first aspect of inner awareness of all of the characters in the supplemental media content selection period 105 prior to making the supplemental media content presentations 106 logically associated with a second aspect of inner awareness of all of the characters in the respective supplemental media content selection period 105. In such an instance, the media content consumer would be required to view all of the supplemental media content presentations 106 logically associated with the thought activities of each character appearing in the narrative presentation 102 during the supplemental media content selection period 105 before being permitted to view the supplemental media content presentations 106 logically associated with the emotional processes, instincts, or bodily sensations of each character appearing in the narrative presentation 102 during the respective supplemental media content selection period 105.

Yet another presentation option is a presentation sequence requiring the media content consumer to view all of the supplemental media content presentations 106 associated with a first character in the narrative presentation 102 during the supplemental media content selection period 105 before being permitted to view the supplemental media content presentations 106 logically associated with a second character included in narrative presentation during the respective supplemental media content selection period 105.

Yet another presentation option is a presentation sequence permitting the simultaneous presentation of a first supplemental media content presentation 106 that is logically associated with a first character appearing in the narrative presentation during the supplemental media content selection period 105 and a second supplemental media content presentation 106 that is logically associated with a second character appearing in the narrative presentation 102 during the respective supplemental media content selection period 105.

Yet another presentation option is a presentation sequence requiring the media content consumer to purchase, win, or otherwise acquire one or more “codes” or similar “keys” to unlock or otherwise access additional supplemental media content presentations 106. The method 900 concludes at 914.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. These and other changes can be made to the embodiments in light of the above-detailed description. Application serial number In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

To the extent it does not contradict this application, U.S. Provisional Application Ser. No. 61/782,261, filed Mar. 14, 2013 is incorporated by reference as if reproduced in its entirety herein.

1. A method for editing at least one supplemental media content presentation into a narrative presentation consisting of a defined sequence of scenes using a processor-based media editing system, the method comprising:
identifying over the course of the narrative presentation a number of supplemental media content selection periods during which at least one supplemental media content presentation is available, each of the selection periods having a respective start point, duration, and end point in the narrative presentation;
for each of the supplemental media content selection periods, providing a number of media content consumer perceptible and selectable indicators in the narrative presentation during all or a portion of the respective supplemental media content period,
each selectable indicator representative of an aspect of inner awareness associated with each of a number of characters; and
each selectable indicator logically associated with a respective supplemental media content presentation including information regarding the respective aspect of inner awareness of the respective character at a point in the narrative presentation selected by the media content consumer; and
for each supplemental media content presentation, identifying at least one respective transition mode between the narrative presentation and each supplemental media content presentation, the respective transition mode specifying a transition effect for segueing between the narrative presentation and the respective supplemental media content presentation.

2. The method of claim 1, further comprising:
identifying over the course of at least one supplemental media content presentation a number of subordinate supplemental media content selection periods during which at least one subordinate supplemental media content presentation is available, each subordinate supplemental media content selection period having a respective start point, duration, and end point in the respective supplemental media content presentation;
for each of the subordinate supplemental media content selection periods, providing a number of media content consumer perceptible and selectable indicators in the supplemental media content presentation during all or a portion of the respective subordinate supplemental media content selection period;
each indicator representative of an aspect of inner awareness for each of a number of characters included in the supplemental media content presentation; and
each indicator logically associated with a respective subordinate supplemental media content presentation including information regarding the respective aspect of inner awareness of the respective character included in the supplemental media content presentation at a point in the supplemental media content presentation selected by the media content consumer; and
for each subordinate supplemental media content presentation, identifying at least one respective transition mode between the supplemental media content presentation and each subordinate supplemental media content presentation, the respective transition mode specifying a transition effect for segueing between the supplemental media content presentation and the respective subordinate supplemental media content presentation.

3. The method of claim 1, further comprising:
identifying a temporal transition relationship between a departure transition event from the narrative presentation to the supplemental media content presentation and return transition event from the supplemental media content presentation to the narrative presentation.

4. The method of claim 3 wherein identifying a temporal transition relationship between the departure transition event from the narrative presentation to the supplemental media content presentation and the return transition event from the supplemental media content presentation to the narrative presentation comprises one of:
identifying the temporal transition relationship that causes the return transition event to return to the narrative presentation at a point in the narrative when the departure transition event occurred; or
identifying the temporal transition relationship that causes the return transition event to return to the narrative presentation at a defined point in the narrative presentation prior to when the departure transition event occurred.

5. The method of claim 3 wherein identifying a temporal transition relationship between the departure transition event from the narrative presentation to the supplemental media content presentation and the return transition event from the supplemental media content presentation to the narrative presentation comprises:
identifying the temporal transition relationship that causes the return transition event to autonomously return to the narrative presentation at the start point of the respective supplemental media content selection period responsive to a selection of a supplemental media content presentation by a media content user within a defined interval prior to the end point of the respective supplemental media content selection period.

6. The method of claim 1 wherein identifying at least one respective transition mode between the narrative presentation and each supplemental media content presentation, the respective transition mode specifying a transition effect for segueing between the supplemental media content presentation and the respective subordinate supplemental media content presentation comprises at least one of:
specifying the transition effect causing a decrease in size of a narrative display area and a contemporaneous increase in size of a supplemental media content display area; and
specifying the transition effect causing a reduction in intensity of a narrative display area and a contemporaneous increase in intensity of a supplemental media content display area.

7. The method of claim 1, further comprising:
for each supplemental media content selection period, selecting a standby mode entered by the narrative presentation while a supplemental media content presentation is provided to a media content consumer.

8. The method of claim 7 wherein selecting a standby mode comprises selecting at least one of:
the standby mode that causes the narrative presentation to halt during the supplemental media content presentation;
the standby mode that causes at least a portion of the narrative existent between a defined start point and a defined end point within the respective supplemental media content selection period to cyclically loop during the supplemental media content presentation; or
the narrative presentation standby mode that causes the narrative presentation to progress at a reduced frame rate during the supplemental media content presentation.

9. The method of claim 1, further comprising:
for each supplemental media content selection period, selecting at least one character included in the narrative presentation, each selected character having at least one associated supplemental media content presentation logically associated with an aspect of inner awareness of the respective character; and
autonomously identifying each of the selected characters by the processor-based media editing system for at least a portion of the duration of the respective supplemental media content selection period.

10. The method of claim 9 wherein autonomously identifying each of the selected characters by the processor-based media editing system for at least a portion of the duration of the respective supplemental media content selection period comprises:
autonomously identifying each of the selected characters using a processor-based facial recognition.

11. The method of claim 1, further comprising:
for each of the supplemental media content selection periods, providing a number of media content consumer perceptible, non-selectable, indicators in the narrative presentation,
each non-selectable indicator representative of an aspect of inner awareness for each of the number of characters; and
each non-selectable indicator logically associated with a respective supplemental media content presentation previously accessed by the media content consumer during the respective supplemental media content selection period.

12. The method of claim 1 wherein for each of the supplemental media content selection periods, providing a number of media content consumer perceptible and selectable indicators in the narrative presentation during all or a portion of the respective supplemental media content period, each indicator representative of one aspect of inner awareness for each of a number of characters comprises:
providing a number of selectable indicators, each representative an aspect of inner awareness that includes at least:
the aspect of inner awareness corresponding to a thought or cognitive activity of the respective character;
the aspect of inner awareness corresponding to an emotion or emotional process of the respective character; and
the aspect of inner awareness corresponding to an instinct or bodily sensation of the respective character.

13. The method of claim 12 wherein providing a selectable indicator representative of an aspect of inner awareness that includes at least: an aspect of inner awareness corresponding to a thought or cognitive activity of the respective character; an aspect of inner awareness corresponding to an emotion or emotional process of the respective character; and an aspect of inner awareness corresponding to an instinct or bodily sensation of the respective character comprises at least one of:
providing in the narrative presentation a selectable indicator representative of the aspect of inner awareness corresponding to a thought or cognitive activity of a narrative character on or about a first portion of a representation of the respective character;
providing in the narrative presentation a selectable indicator representative of the aspect of inner awareness corresponding to an emotion or emotional process of a narrative character on or about a second portion of a representation of the respective character; and
providing in the narrative presentation a selectable indicator representative of the aspect of inner awareness corresponding to an instinct or bodily sensation of a narrative character on or about a third portion of a representation of the respective character.

14. The method of claim 12 wherein providing a selectable indicator representative of an aspect of inner awareness that includes at least: an aspect of inner awareness corresponding to a thought or cognitive activity of the respective character; an aspect of inner awareness corresponding to an emotion or emotional process of the respective character; and an aspect of inner awareness corresponding to an instinct or bodily sensation of the respective character comprises at least one of:
providing in the narrative presentation a selectable indicator representative of the aspect of inner awareness corresponding to a thought or cognitive activity of the respective character on or about a head portion of a representation of the respective character;
providing in the narrative presentation a selectable indicator representative of the aspect of inner awareness corresponding to an emotion or emotional process of the respective character on or about a chest portion of a representation of the respective character; and
providing in the narrative presentation a selectable indicator representative of the aspect of inner awareness corresponding to an instinct or bodily sensation of the respective character on or about an abdominal portion of a representation of the respective character.

15. The method of claim 1, further comprising:
selecting at least one display parameter for each of the number of selectable indicators.

16. The method of claim 15 wherein selecting at least one display parameter comprises:
selecting at least one display effect on or proximate at least one of:
a media content consumer selectable indicator including an icon logically associated with a supplemental media content presentation logically associated with the respective character; and
a media content consumer selectable indicator including an indicator disposed on or about all or a portion of a representation of a character, the indicator logically associated with a supplemental media content presentation logically associated with the respective character.

17. The method of claim 16 wherein selecting at least one display effect includes selecting at least one of:
a change in display intensity;
a change in display color; and
a cyclical change in alternating portions of display location to cause a shimmer or halo effect.

18. The method of claim 16 wherein selecting at least one display effect on or proximate a media content consumer selectable indicator including an indicator disposed on or about all or a portion of a representation of a narrative character comprises selecting at least one of:
a display effect directly on or proximate at least a portion of a representation of the respective character appearing in the narrative presentation; or
a display effect directly on or proximate at least a portion of a representation corresponding to the respective character appearing external to the narrative presentation.

19. The method of claim 15 wherein selecting at least one display parameter for each of the number of selectable indicators further comprises:
selecting a duration of the at least one display effect in the narrative presentation equal to a duration of the respective supplemental media content selection period; and
selecting a duration of the at least one display effect in the narrative presentation less than a duration of the respective supplemental media content selection period.

20. The method of claim 1, further comprising:
for each of the number of selectable indicators, identifying a media content consumer input indicative of a selection of the respective indicator.

21. The method of claim 20 wherein identifying a media content consumer input indicative of a selection of the respective indicator comprises at least one of:
identifying a non-contact, gesture based, input using a human hand or pointer to indicate selection of the respective indicator;
identifying a contact, touch based, input using a human hand or pointer to indicate selection of the respective indicator; and
identifying a pointer based input using a pointing device to indicate selection of the respective indicator.

22. The method of claim 1 wherein providing a number of media content consumer perceptible and selectable indicators in the narrative presentation during all or a portion of the respective supplemental media content period, each indicator representative of an aspect of inner awareness for each of a number of characters included in the narrative; and each indicator logically associated with a respective supplemental media content presentation including information regarding the respective aspect of inner awareness of the respective character at a point in the narrative presentation selected by the media content consumer; comprises:
providing a number of media content consumer perceptible and selectable indicators in the narrative presentation during all or a portion of the respective supplemental media content period, each indicator representative of an aspect of inner awareness for each of at least two characters included in the narrative; and each indicator logically associated with a respective supplemental media content presentation including information regarding the respective aspect of inner awareness of the respective character at a point in the narrative presentation selected by the media content consumer.

23. The method of claim 22, further comprising:
defining a presentation sequence for each of the number of supplemental media content presentations logically associated with each of the at least two characters included in the narrative presentation.

24. The method of claim 23 wherein defining a presentation sequence for the number of supplemental media content presentations logically associated each of the at least two narrative characters comprises:
defining a presentation sequence that causes the presentation of each of the number of supplemental media content presentations logically associated with a first character included in the narrative presentation prior to a presentation of any of the number of supplemental media content portions logically associated with a second character included in the narrative presentation.

25. The method of claim 24 wherein defining a presentation sequence that causes the presentation of each of the number of supplemental media content presentations logically associated with a first character included in the narrative presentation prior to a presentation of any of the number of supplemental media content portions logically associated with a second character included in the narrative presentation comprises at least one of:
defining a presentation sequence that causes the presentation of each of the number of supplemental media content presentations logically associated with the first character included in the narrative presentation prior to the presentation of any of the number of supplemental media content presentations logically associated with the second character included in the narrative presentation for the duration of each supplemental media content period; or
defining a presentation sequence that causes the presentation of each of the number of supplemental media content presentations logically associated with the first character included in the narrative presentation prior to the presentation of any of the number of supplemental media content presentations logically associated with the second character included in the narrative presentation for a duration narrative presentation.

26. The method of claim 23 wherein defining a presentation sequence for the number of supplemental media content presentations logically associated each of the at least two narrative characters comprises:
defining a presentation sequence that causes the presentation of each of the number of supplemental media content presentations logically associated with at least one of the aspects of inner awareness associated with the first character included in the narrative presentation prior to the presentation of any of the number of supplemental media content presentations logically associated with at least one of the aspects of inner awareness associated with the second character included in the narrative presentation.

27. The method of claim 23 wherein defining a presentation sequence for the number of supplemental media content presentations logically associated each of the at least two characters included in the narrative comprises:
defining by the media content consumer a presentation sequence for the presentation of each of a number of supplemental media content presentations for each of the at least two characters.

28. The method of claim 27 wherein defining by the media content consumer a presentation sequence for the presentation of each of a number of supplemental media content presentations for each of the at least two characters comprises:
defining by the media content consumer a presentation sequence for the presentation of each of a number of supplemental media content presentations for each of the at least two characters corresponding to a selectable indicator selection sequence provided by the media content consumer.

29. A system for editing at least one supplemental media content presentation into a narrative presentation consisting of a defined sequence of scenes, the system comprising:
a first nontransitory storage including data representative of the narrative presentation and a number of supplemental media content presentations;
at least one user interface; and
at least one processor with machine executable instructions that when executed by the at least one processor, cause the at least one processor to provide a user with the ability via the at least one user interface to:
identify over the course of the narrative presentation a number of supplemental media content selection periods during which at least one supplemental media content presentation is available, each of the selection periods having a respective start point, duration, and end point in the narrative presentation;
for each of the supplemental media content selection periods, provide a number of media content consumer perceptible and selectable indicators in the narrative presentation during all or a portion of the respective supplemental media content period,
each selectable indicator representative an aspect of inner awareness associated with each of a number of characters included in the narrative presentation; and
each indicator logically associated with a respective supplemental media content presentation including information regarding the respective aspect of inner awareness of the respective character at a point in the narrative presentation selected by the media content consumer; and
for each supplemental media content presentation, identify at least one respective transition mode between the narrative presentation and each supplemental media content presentation, the respective transition mode specifying a transition effect for segueing between the narrative presentation and the respective supplemental media content presentation.

30. The system of claim 29, wherein the machine executable instructions further cause the at least one processor to provide a user with the ability via the user interface to:
identify over the course of at least one supplemental media content presentation a number of subordinate supplemental media content selection periods during which at least one subordinate supplemental media content presentation is available, each subordinate supplemental media content selection period having a respective start point, duration, and end point in the respective supplemental media content presentation;
for each of the subordinate supplemental media content selection periods, provide a number of media content consumer perceptible and selectable indicators in the supplemental media content presentation during all or a portion of the respective subordinate supplemental media content selection period;
each selectable indicator representative of an aspect of inner awareness for each of a number of characters included in the respective supplemental media content presentation; and
each indicator logically associated with a respective subordinate supplemental media content presentation including information regarding the respective aspect of inner awareness of the respective character at a point in the supplemental media content presentation selected by the media content consumer; and
for each supplemental media content presentation, identify at least one respective transition mode between the supplemental media content presentation and each subordinate supplemental media content presentation, the respective transition mode specifying a transition effect for segueing between the supplemental media content presentation and the respective subordinate supplemental media content presentation.

31. The system of claim 29 wherein the machine executable instructions further cause the at least one processor to provide a user with the ability via the user interface to:
identify a temporal transition relationship between a departure transition event from the narrative presentation to the supplemental media content presentation and return transition event from the supplemental media content presentation to the narrative presentation.

32. The system of claim 31 wherein the temporal transition relationship comprises one of:
the temporal transition relationship that causes the return transition event to return to the narrative presentation at a point in the narrative when the departure transition event occurred; or
the temporal transition relationship that causes the return transition event to return to the narrative presentation at a defined point in the narrative presentation prior to when the departure transition event occurred.

33. The system of claim 31 wherein the temporal transition relationship comprises the relationship that causes the return transition event to autonomously return to the narrative presentation at the start point of the respective supplemental media content selection period responsive to a selection of a supplemental media content presentation by a media content user within a defined interval prior to the end point of the respective supplemental media content selection period.

34. The system of claim 29 wherein the machine executable instructions further cause the at least one processor to provide the user with the ability via the user interface to:
specify the transition effect that causes a decrease in size of a narrative presentation display area and a contemporaneous increase in size of a supplemental media content presentation display area; and
specify the transition effect that causes a reduction in intensity of a narrative presentation display area and a contemporaneous increase in intensity of a supplemental media content presentation display area.

35. The system of claim 29 wherein the machine executable instructions further cause the at least one processor to provide the user with the ability via the user interface to:
for each supplemental media content selection period, select a standby mode entered by the narrative presentation while a supplemental media content presentation is provided to a media content consumer.

36. The system of claim 35 wherein the standby mode comprises at least one of:
the standby mode that causes the narrative presentation to halt during the supplemental media content presentation;
the standby mode that causes at least a portion of the narrative existent between a defined start point and a defined end point within the respective supplemental media content selection period to cyclically loop during the supplemental media content presentation; or
the standby mode that causes the narrative presentation to progress at a reduced frame rate during the supplemental media content presentation.

37. The system of claim 29 wherein the machine executable instructions further cause the at least one processor to provide the user with the ability via the user interface to:
for each supplemental media content selection period, select at least one character in the narrative presentation, each selected character having at least one associated supplemental media content presentation logically associated with an aspect of inner awareness; and
autonomously identify each of the selected characters using facial recognition for at least a portion of the duration of the respective supplemental media content selection period.

38. The system of claim 29 wherein the machine executable instructions further cause the at least one processor to provide the user with the ability via the user interface to:
for each of the supplemental media content selection periods, provide a number of media content consumer perceptible, non-selectable, indicators in the narrative presentation,
each non-selectable indicator representative of an aspect of inner awareness for each of the number of narrative characters; and
each non-selectable indicator logically associated with a respective supplemental media content presentation previously accessed by the media content consumer during the respective supplemental media content selection period.

39. The system of claim 29 wherein the machine executable instructions further cause the at least one processor to provide the user with the ability via the user interface to:
provide a selectable indicator representative of an aspect of inner awareness that includes at least:
the aspect of inner awareness corresponding to a thought or cognitive activity of the respective character;
the aspect of inner awareness corresponding to an emotion or emotional process of the respective character; and
providing in the narrative a selectable indicator representative of the aspect of inner awareness corresponding to an instinct or bodily sensation of the respective character.

40. The system of claim 39 wherein the machine executable instructions further cause the at least one processor to provide the user with the ability via the user interface to:
provide in the narrative presentation a selectable indicator representative of the aspect of inner awareness corresponding to a thought or cognitive activity of a narrative character on or about a first portion of a representation of the respective character;
provide in the narrative presentation a selectable indicator representative of the aspect of inner awareness corresponding to an emotion or emotional process of a narrative character on or about a second portion of a representation of the respective character; and
provide in the narrative presentation a selectable indicator representative of the aspect of inner awareness corresponding to an instinct or bodily sensation of a narrative character on or about a third portion of a representation of the respective character.

41. The system of claim 39 wherein the machine executable instructions further cause the at least one processor to provide the user with the ability via the user interface to:
provide in the narrative presentation a selectable indicator representative of the aspect of inner awareness corresponding to a thought or cognitive activity of the respective character on or about a head portion of a representation of the respective character;
provide in the narrative presentation a selectable indicator representative of the aspect of inner awareness corresponding to an emotion or emotional process of the respective character on or about a chest portion of a representation of the respective character; and
provide in the narrative presentation a selectable indicator representative of the aspect of inner awareness corresponding to an instinct or bodily sensation of the respective character on or about an abdominal portion of a representation of the respective character.

42. The system of claim 29 wherein the machine executable instructions further cause the at least one processor to provide the user with the ability via the user interface to:
select at least one display parameter for each of the number of selectable indicators.

43. The system of claim 42 wherein the machine executable instructions further cause the at least one processor to provide the user with the ability via the user interface to:
select at least one display effect on or proximate at least one of:
a media content consumer selectable indicator including an icon logically associated with a supplemental media content presentation logically associated with the respective character; and
a media content consumer selectable indicator including an indicator disposed on or about all or a portion of a representation of a narrative character, the indicator logically associated with a supplemental media content presentation logically associated with the respective character.

44. The system of claim 43 wherein the machine executable instructions further cause the at least one processor to provide the user with the ability via the user interface to:
select at least one display effect that includes at least one of:
a change in display intensity;
a change in display color; and
a cyclical change in alternating portions of display location to cause a shimmer or halo effect.

45. The system of claim 43 wherein the machine executable instructions further cause the at least one processor to provide the user with the ability via the user interface to:
select at least one display effect on or proximate a media content consumer selectable indicator including an indicator disposed on or about all or a portion of a representation of a character included in the narrative presentation including at least one of:
a display effect directly on or proximate at least a portion of a representation of the respective character included in the narrative presentation; or
a display effect directly on or proximate at least a portion of a representation of the respective character external to the narrative presentation.

46. The system of claim 42 wherein the machine executable instructions further cause the at least one processor to provide the user with the ability via the user interface to:
select at least one display parameter for each of the number of selectable indicators including at least one of:
a duration of the at least one display effect in the narrative presentation equal to a duration of the respective supplemental media content selection period; and
a duration of the at least one display effect in the narrative presentation less than a duration of the respective supplemental media content selection period.

47. The system of claim 29 wherein the machine executable instructions further cause the at least one processor to provide the user with the ability via the user interface to:
for each of the number of selectable indicators, identify a media content consumer input indicative of a selection of the respective indicator.

48. The system of claim 47 wherein the machine executable instructions further cause the at least one processor to provide the user with the ability via the user interface to identify a media content consumer input indicative of a selection of the respective indicator including at least one of:
a non-contact, gesture based, input using a human hand or pointer to indicate selection of the respective indicator;
a contact, touch based, input using a human hand or pointer to indicate selection of the respective indicator; and
a pointer based input using a pointing device to indicate selection of the respective indicator.

49. The system of claim 29 wherein the machine executable instructions further cause the at least one processor to provide the user with the ability via the user interface to:
provide a number of media content consumer perceptible and selectable indicators in the narrative presentation during all or a portion of the respective supplemental media content period, each indicator representative of an aspect of inner awareness for each of at least two characters included in the narrative presentation; and each selectable indicator logically associated with a respective supplemental media content presentation including information regarding the respective aspect of inner awareness of the respective character at a point in the narrative presentation selected by the media content consumer.

50. The system of claim 49 wherein the machine executable instructions further cause the at least one processor to provide the user with the ability via the user interface to:
define a presentation sequence for each of the number of supplemental media content presentations logically associated with each of the at least two characters included in the narrative presentation.

51. The system of claim 50 wherein the machine executable instructions further cause the at least one processor to provide the user with the ability via the user interface to:
define a presentation sequence that causes the presentation of each of the number of supplemental media content presentations logically associated with a first character included in the narrative presentation prior to a presentation of any of the number of supplemental media content portions logically associated with a second character included in the narrative presentation.

52. The system of claim 51 wherein the presentation sequence includes at least one of:
a presentation sequence that causes the presentation of each of the number of supplemental media content presentations logically associated with the first character included in the narrative presentation prior to the presentation of any of the number of supplemental media content presentations logically associated with the second character included in the narrative presentation for the duration of each supplemental media content period; or
a presentation sequence that causes the presentation of each of the number of supplemental media content presentations logically associated with the first character included in the narrative presentation prior to the presentation of any of the number of supplemental media content presentations logically associated with the second character included in the narrative presentation for a duration of the narrative presentation.

53. The system of claim 50 wherein the machine executable instructions further cause the at least one processor to provide the user with the ability via the user interface to:
define a presentation sequence that causes the presentation of each of the number of supplemental media content presentations logically associated with at least one of the aspects of inner awareness associated with the first character included in the narrative presentation prior to the presentation of any of the number of supplemental media content presentations logically associated with at least one of the aspects of inner awareness associated with the second character included in the narrative presentation.

54. The system of claim 50 wherein the machine executable instructions further cause the at least one processor to provide the user with the ability via the user interface to:
define by the media content consumer a presentation sequence for the presentation of each of a number of supplemental media content presentations for each of the at least two characters included in the narrative presentation.

55. The system of claim 54 wherein the machine executable instructions further cause the at least one processor to provide the user with the ability via the user interface to:
define by the media content consumer a presentation sequence for the presentation of each of a number of supplemental media content presentations for each of the at least two characters included in the narrative presentation corresponding to a selectable indicator selection sequence provided by the media content consumer.

56. The system of claim 50 wherein the machine executable instructions further cause the at least one processor to provide the user with the ability via the user interface to:
define a presentation sequence that causes the simultaneous presentation of a first supplemental media content presentation logically associated with a first character included in the narrative presentation during a supplemental media content selection period and a second supplemental media content presentation logically associated with a second character included in the narrative presentation during the supplemental media content selection period.
